(19) United States
(12) Patent Application Publication
(10) Pub. No.: US 2014/0032255 A1
(43) Pub. Date: Jan. 30, 2014

(54) SYSTEM AND METHOD FOR SCHEDULE OPTIMIZATION

(71) Applicant: Tarek Mohamed Mohamed Hegazi, Waterloo (CA)

(72) Inventor: Tarek Mohamed Mohamed Hegazi, Waterloo (CA)

(21) Appl. No.: 14/005,938

(22) PCT Filed: Mar. 21, 2012
(86) PCT No.: PCT/CA2012/000311

§ 371 Date: Oct. 17, 2013

Related U.S. Application Data
(60) Provisional application No. 61/457,406, filed on Mar. 21, 2011.
(60) Provisional application No. 61/457,407, filed on Mar. 21, 2011.

(51) Int. Cl. G06Q 10/06

(52) U.S. Cl. CPC G06Q 10/06312
USPC 705/7.22

(57) ABSTRACT

There is disclosed a system and method for tracking of the progress of scheduled tasks, and for schedule optimization of projects using a heuristic method. In an embodiment, the method comprises: starting the time-cost trade-off (TCT) process by resetting project activities to their cheapest options with the longest project duration; while in any TCT cycle all critical activities are not crashed, selecting and crashing the cheapest critical activities one-by-one to reduce the project's critical path; when in any TCT cycle all critical project activities are crashed, then crashing the cheapest non-critical activities one-by-one; performing a constrained resource scheduling (CRS) analysis at the end of each TCT cycle to meet project resource limits and provide at least one feasible solution for a project duration that does not violate project resource limits; saving the best solution with cheapest total cost from any cycle; and performing a time-cost trade-off (TCT) analysis within each cycle to consider all costs. In another aspect, there is disclosed a system and method for collecting data for schedule optimization, selecting an eligible project activity for which a progress update is required, and obtaining contact information for a user device associated with the project activity; initiating contact with the user device to request a progress update collecting from the user device required progress information for the project activity; and updating progress information for the project activity based on the progress update collected from the user device.

### CROSS-REFERENCE TO RELATED APPLICATIONS

The present application claims priority from U.S. Provisional Application No. 61/457,406, filed on Mar. 21, 2011, and U.S. Provisional Application No. 61/457,407, filed on Mar. 21, 2011.

### FIELD

The present disclosure relates to a system and method for tracking the progress of scheduled tasks, and for schedule optimization of projects using a novel heuristic method.

### BACKGROUND

Project deadline and resource limits are practical constraints that co-exist in most projects. While heuristic methods for Constrained Resource Scheduling (CRS) have become mainstream in commercial scheduling software, they often lack capabilities in resolving deadlines and meeting resource restraints.

In another aspect, collecting timely and accurate site information is essential for assessing project performance, deciding corrective actions, and documenting as-built details. Information collection, however, has been a manual process that is time-consuming and error-prone.

In another aspect, as-built information is essential for progress tracking, corrective actions, and schedule analysis. As-built documentation, however, has mainly been a manual process that is time-consuming and errors-prone.

What is needed is an improved system and method for schedule optimization which addresses these limitations.

### SUMMARY

The present disclosure relates to a system and method for tracking the progress of scheduled tasks, and for schedule optimization of projects using a heuristic novel method.

In one aspect, the present system and method uses voice and visual tracking to determine the progress of tasks to be performed in the course of a project. While many mainstream commercial scheduling software utilize heuristic methods for Constrained Resource Scheduling, to the knowledge of the inventor, no commercial software presently includes a Time-Cost Trade-Off (TCT) heuristic to help meet deadlines or to resolve both deadline and resource constraints.

Thus, the present disclosure proposes a practical heuristic system and method to meet both deadline and resource limits concurrently. The proposed method basically uses cycles of crashing for lowest-cost critical activities (i.e., stepwise TCT process) and resolves any resource over-allocation (i.e., CRS) within each TCT cycle. This intertwined approach is logical, fast, and provides a set of feasible project durations that do not violate resource limits. To facilitate its practical use, the proposed method has been programmed as an add-in tool to

Microsoft Project software. The disclosure discusses several case studies that prove the practicality and usefulness of the proposed approach to both researchers and professionals and provides a comparison of results with other literature efforts. Therefore, what is needed is a solution to help individuals overcome at least some of these limitations.

In another aspect, to improve the tracking of site information, the present disclosure proposes a voice/visual approach for communicating among project participants and collecting daily site information. The disclosure discusses the cost-effective information technology (IT) tools such as email, internet-based telephony, SMS (Short Message Service) that are available commercially at low-cost. The disclosure then proposes a framework for site information collection that combines these IT tools with a scheduling system. In an embodiment, the framework can be implemented on a handheld device that allows both voice and visual communication and documentation. This system has the ability to capture all daily site information related to each activity along with supporting documents (photos, video, audio, as-built sketches, and other documents). As such, it helps in thoroughly and effortlessly documenting the evolution of the construction progress and its as-built outcome. The proposed system allows construction firms better control over construction operations and provides timely data for decision making, which can lead to better productivity and fewer disputes.

In an aspect, there is provided a computer implemented method for schedule optimization, comprising: starting a time-cost trade-off (TCT) analysis by resetting project activities to their cheapest options with the longest project duration; in any TCT cycle, while all critical activities are not crashed, selecting and crashing the cheapest critical activities one-by-one to reduce the project's critical path; in any TCT cycle, when all critical project activities are crashed, then crashing the cheapest non-critical activities one-by-one; performing a constrained resource scheduling (CRS) analysis at the end of each TCT cycle to meet project resource limits and provide at least one feasible solution for a project duration that does not violate project resource limits; and saving the best solution with cheapest total cost from any cycle.

In another aspect, there is provided a system for schedule optimization, wherein the system is adapted to: start a time-cost trade-off (TCT) analyis by resetting project activities to their cheapest options with the longest project duration; in any TCT cycle, while all critical activities are not crashed, select and crash the cheapest critical activities one-by-one to reduce the project's critical path; in any TCT cycle, when all critical project activities are crashed, then crash the cheapest non-critical activities one-by-one; perform a constrained resource scheduling (CRS) analysis at the end of each TCT cycle to meet project resource limits and provide at least one feasible solution for a project duration that does not violate project resource limits; and save the best solution with cheapest total cost from any cycle.

In another aspect, there is provided a computer implemented method for collecting data for schedule optimization, comprising: automatically identifying and selecting an eligible project activity for which a progress update is required, and obtaining contact information for a user device associated with the project activity; initiating contact with the user device to request a progress update; collecting from the user device required progress information for the project activity; and updating progress information for the project activity based on the progress update collected from the user device.

In another aspect, there is provided a system or collecting data for schedule optimization, wherein the system is adapted to: automatically identify and select an eligible project activity for which a progress update is required, and obtaining contact information for a user device associated with the project activity; initiate contact with the user device to request a progress update; collect from the user device required progress information for the project activity; and update progress information for the project activity based on the progress update collected from the user device.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates resolving resource conflicts over using start-delays.

FIG. 2 illustrates using fast construction methods to meet a deadline.

FIG. 3 illustrates meeting both project deadline and resource limits.

FIG. 4 illustrates applying constrained resource scheduling (CRS) to an example.

FIG. 5 illustrates applying time-cost trade-off (TCT) to an example.

FIG. 6 illustrates applying a proposed system method combining CRS and TCT analysis in accordance with an embodiment.

FIG. 7 illustrates a schematic flowchart of the heuristic method combining CRS and TCT analysis in accordance with an embodiment.

FIG. 8 illustrates a program combining CRS and TCT analysis in accordance with an embodiment.

FIG. 9 illustrates an example of applying a combined CRS and TCT analysis in accordance with another embodiment.

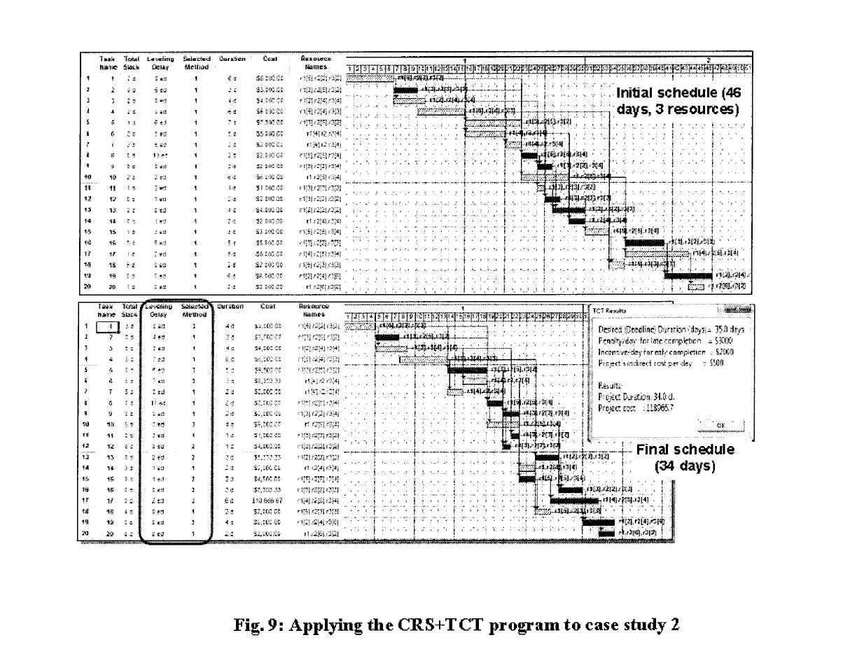

FIG. 10 illustrates a proposed framework for combining email, internet-based telephony, and visualization tools into a single framework to send and receive activities' information in accordance with an embodiment.

FIG. 11 illustrates two sample information flow scenarios for daily events in pavement construction in accordance with an embodiment.

FIG. 12 illustrates a call flow diagram for a set of questions that can be programmed in a voice call, email, etc. for obtaining complete site information from supervisory personnel in accordance with an embodiment.

FIG. 13 illustrates a schematic flow diagram of the system and method in accordance with an embodiment.

FIG. 14 illustrates different levels of as-built details have different implications in accordance with an embodiment.

FIG. 15 illustrates an example of an email form in accordance with an embodiment.

FIG. 16 illustrates an example of components of the proposed as-built tracking framework in accordance with an embodiment.

FIG. 17 illustrates a sample project communication list in accordance with an embodiment.

FIG. 18 illustrates a bridge-pier foundation example and main system options in accordance with an embodiment.

FIG. 19 illustrates an email-based as-built tracking process in accordance with an embodiment.

FIG. 20 illustrates a received email response saved in a project folder in accordance with an embodiment.

FIG. 21 illustrates an information request sent to responsible person in accordance with an embodiment.

FIG. 22 illustrates a log of email communications and schedule reports in accordance with an embodiment.

FIG. 23 illustrates a generic computer system which may provide a suitable operating environment for various embodiments.

### DETAILED DESCRIPTION

As noted above, the present disclosure relates to a system and method for tracking of the progress of scheduled tasks, and for schedule optimization of projects using a heuristic method.

In an aspect, existing project management is based on the well known Critical path Method (CPM), which has many problems, including: (1) CPM allows complex relations among project tasks, which result in inaccurate computations of float times and critical activities; (2) CPM does not allow recording and representation of mid-activity events such as rework and other progress event, accordingly, is difficult to analyze project delays and assign responsibility; and (3) CPM is not suited to repetitive projects such as highways, high-rises, and multiple scattered units (e.g., infrastructure facilities).

Persistent CPM problems stem from using complex relations among project tasks that cause it to produce inaccurate computations. This is added to the inability to represent mid activity events. These complexities do not allow accurate allocation of responsibility for project delays among the various parties. Moreover, CPM is not suited to repetitive projects such as highways, high-rises, and multiple units (e.g., many housing units). In addition, the schedule details are not tied in a simple manner to the physical locations of the project items. A lot of research exists in various related areas, including repetitive scheduling, introducing new float calculation, and introducing new relationships. All these developments are still based on the traditional CPM method, and as such, suffer from CPM drawbacks of inaccurate results.

The present disclosure introduces a new project management method, with a new scheduling method developed by the inventors called Critical Path Segments (CPS) in which activity duration is not a continuous block of time, rather a group of segmented time segments attached to each other. The new system also has innovative scheduling features such as automatic conversion of all project relations to finish-to-start, representation of mid-activity events, and correct float calculations. The disclosure introduces innovative framework and procedures as follows: (i) procedure for representing activities using separate time segments of different types; (ii) procedure for converting activity relations into finish-to-start between time segments; (iii) procedure for documenting mid-activity events using different types of time segments; & (iv) method for critical path scheduling and reporting of single and multiple projects involving repetitive and non-repetitive activities with separate time segments and different types of constraints.

In another aspect, existing project management methods such as the traditional Critical path Method (CPM) and linear/repetitive scheduling methods suffer from various limitations, including: (1) collecting information about progress and as-built details is a manual process that is time-consuming, lacks automation, and is prone to errors; (2) all methods are not designed to respect a combination of deadline, resource limit, budget, and other types of constraints, therefore do not provide economical schedules, particularly for projects that involve a combination of repetitive and non-repetitive activities; and (3) existing methods do not allow accurate analysis of the schedules that involve rework and various other progress events. Accordingly, it may be difficult to analyze project delays and assign responsibility.

In various aspects the present disclosure introduces a new project control and schedule optimization framework and introduces a number of novel procedures, including a system and method for: voice or visual information tracking; heuristic optimization of project schedules considering various constraints; evolutionary/mathematical optimization of project schedules; and control, delay analysis, and visual reporting.

In practice, CPM and PERT scheduling techniques have proven to be helpful when the project deadline is not fixed and the resources are not constrained. However, because a CPM formulation does not incorporate a deadline or resource limits, other techniques must be applied separately after the initial CPM schedule is determined. Two of the supplementary techniques for CPM scheduling are briefly highlighted below.

### Constrained Resource Scheduling (CRS)

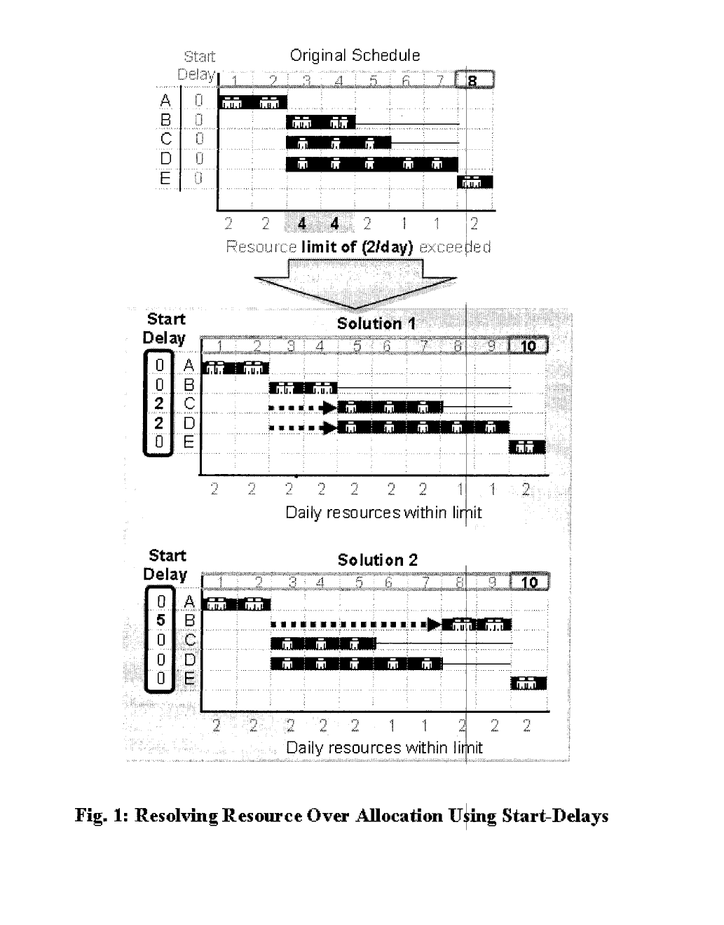

In most practical situations, project resources are available only in limited amounts, particularly when resources are used for multiple activities or even multiple projects (Lu and Li 2003). Several exact, metaheuristic, and heuristic methods have been proposed for solving the CRS problem in which several activities run in parallel, thus requiring more resources than available. The goal of all these methods is to find an optimal or near optimal solution to resolve the resource over-allocation, even at the expense of increased project duration. A simple way to represent a solution (Hegazy 2002) is using start delay values that need to be imposed on the activities so that fewer activities run in parallel. FIG. 1 shows a small example where activities B, C, and D run in parallel, thus requiring more resources than available. As shown in the top solution, a set of start delays for the activities [0, 0, 2, 2, are used to resolve the resource over allocation but the project had to be extended from 8 to 10 days. It is noted that the start delay of an activity is applied beyond the end of its predecessors, thus preserves the original logical relationships in the project. It is also noted that the quality of the solution is dependent on the start-delay values, and it is possible to have more than one equally-good solution (i.e., equal project duration), as in the case of the two solutions in FIG. 1, where the solutions can vary in their resulting resource profiles. In addition, the more the activities and the resources to consider, the exponentially larger the number of combinations of start-delay values, which makes the search for an optimum solution a difficult task.

Exact CRS methods, such as dynamic programming (Elmaghraby 1993), zero-one programming (Son and Mattila 2004), and implicit enumeration with branch and bound (Jiang and Shi 2005) are difficult to formulate and often fail to handle the complexity involved. Metaheuristic methods such as genetic algorithms (Hegazy 1999) and simulated annealing (Son and Skibniewski 1999), on the other hand, can efficiently explore the entire solution space using random search techniques and can find several good solutions, which is useful for decision makers (Lucko 2011). Metaheuristic procedures, however, require problem-dependent parameter tuning, large computational time, and do not guaranteed to find optimal project schedules (Hariga and El-Sayegh 2011), thus presenting a challenge for large projects.

Heuristic methods, such as priority-based scheduling (Christodoulou et al. 2010, Harris 1990, Hiyassat 2001), can find a solution very quickly, which makes them very practical. While heuristic solutions are not guaranteed to find the optimal solution, they can provide a near optimal one (Kastor and Sirakoulis 2009). Almost all project management software, such as Primavera Project Planner and Microsoft Project, employ priority-based heuristics for resolving resource over allocation. For example, the resource “leveling” tool in Microsoft Project software heuristically resolves resource constraints by assigning higher priorities to some activities based on: total float and user-specified priority (Christodoulou et al. 2010). In this case, activities with high priorities are given the resources first while other activities are delayed until the occupied resources are freed. Resource leveling has thus become mainstream in existing software systems.

### Time-Cost Trade-Off (TCT) Analysis

TCT analysis is a technique used to overcome CPM's lack of ability to confine the schedule to a specified duration. The objective of the analysis is to reduce the original CPM duration of a project in order to meet a specific deadline with the minimum cost (Chassiakos and Sakellaropoulos 2005). TCT analysis is an important management tool because it can be used to accelerate a project so that delays can be recovered and liquidated damages avoided. The project can be accelerated through the addition of resources, e.g., people/equipment or through the addition of work hours, to crash critical activities (the ones that govern project duration). As such, TCT algorithms determine the cheapest critical activity that needs a faster construction method (even if it is more expensive). Reducing project duration therefore results in an increase in direct costs (e.g., materials, labor, and equipment), which can be justified if the indirect costs (e.g., expenditures for management and supervision) are reduced or if a bonus is earned due to faster project completion (Gould 2005).

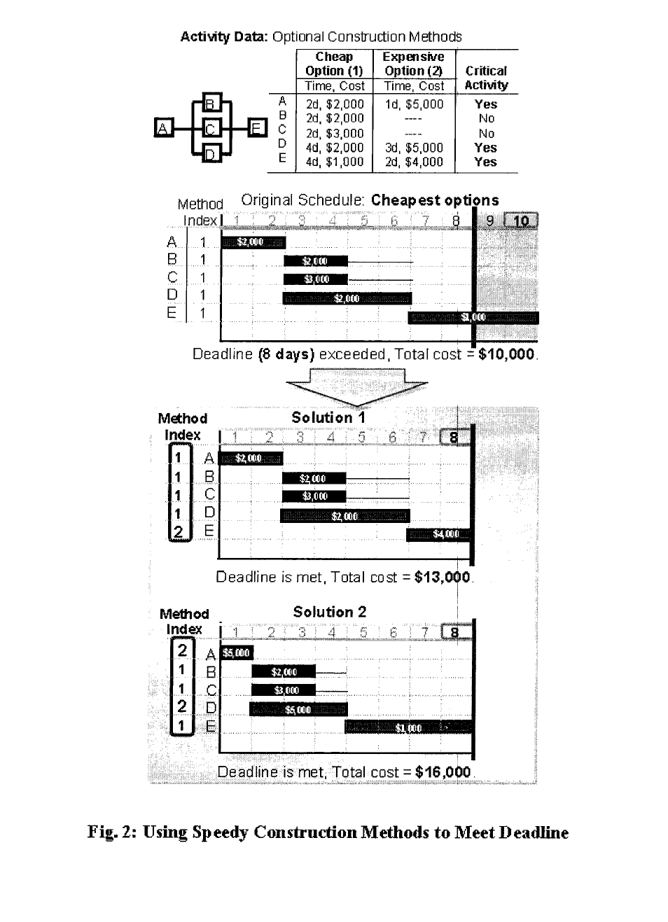

A simple way to represent TCT solution (Hegazy 2002) is using a set of numbers that represent the indices to the construction method to use in each activity (FIG. 2). The small example in FIG. 2 shows that when each activity uses its cheapest construction method (i.e., the solution set is [1, 1, 1, 1, 1]), the project is cheapest (assuming no indirect costs for simplicity) but the CPM duration of the project exceeds an 8-day deadline. To meet the deadline, two possible solutions are shown with their solution sets (construction method indices) at the bottom of FIG. 2. It is also noted that TCT analysis requires readily available data about the durations and costs of optional construction methods for the various activities. Moreover, similar to the case of CRS, the quality of the TCT solution is dependent on the values used in the solution set. For example, solution 1 in FIG. 2 is better than solution 2 since it meets the deadline with a cheaper total cost. It is also possible to have more than one equally-good solution and, as expected, the larger the number of activities and their options, the exponentially larger the number of combination of constriction method values, which makes the search for an optimum solution a difficult task. Similar to CRS, many research efforts have presented TCT models using optimization, metaheuristics, and simple heuristic procedures. Recent research includes Chassiakos and Sakellaropoulos (2005), Vanhoucke and Debels (2007), Eshtehardian et al. (2008), Rogalska et al. (2008), and Ammar (2011). Despite the proliferation of models, unfortunately, no commercial software incorporates ready-to-use algorithms for TCT analysis, let alone a combination of CRS and TCT models used concurrently during an optimization process.

### Integrated Optimization Efforts

Real-life projects often involve multiple constraints and challenges, including the combination of project deadline and limited resources. While the literature describes several techniques to resolve these constraints individually, as mentioned earlier, little effort has been devoted to considering them simultaneously due to the higher modeling complexity involved. The few available studies that provide overall project optimization use metaheuristics, mostly Genetic Algorithms (GAs) which are non-traditional evolutionary optimization tools that use a random search process to arrive at near-optimum solutions for difficult and large size problems.

Leu and Yang (1999) proposed one of the earliest models that integrate TCT and CRS using genetic algorithms. Senouci and Eldin (2004) presented another integrated model and used an augmented I,agrangian genetic algorithm for the optimization. Elazouni and Metwally (2007) also used genetic algorithms to expand finance-based scheduling and integrate the techniques of TCT analysis, resource allocation, and resource leveling. Chen and Weng (2009) presented a GA-based model that segments the optimization into two phases, where TCT is applied first, followed by another GA model for CRS. Zahraie and Tavakolan (2009) embedded the two concepts of time-cost trade-off and resource leveling and allocation in a stochastic multi-objective optimization using a modified genetic algorithm model. Wuliang and Chengen (2009) also presented a multi-mode resource-constrained discrete time/cost tradeoff model. They developed an improved genetic algorithm to consider time constraints, renewable resource constraints, and cost constraints.

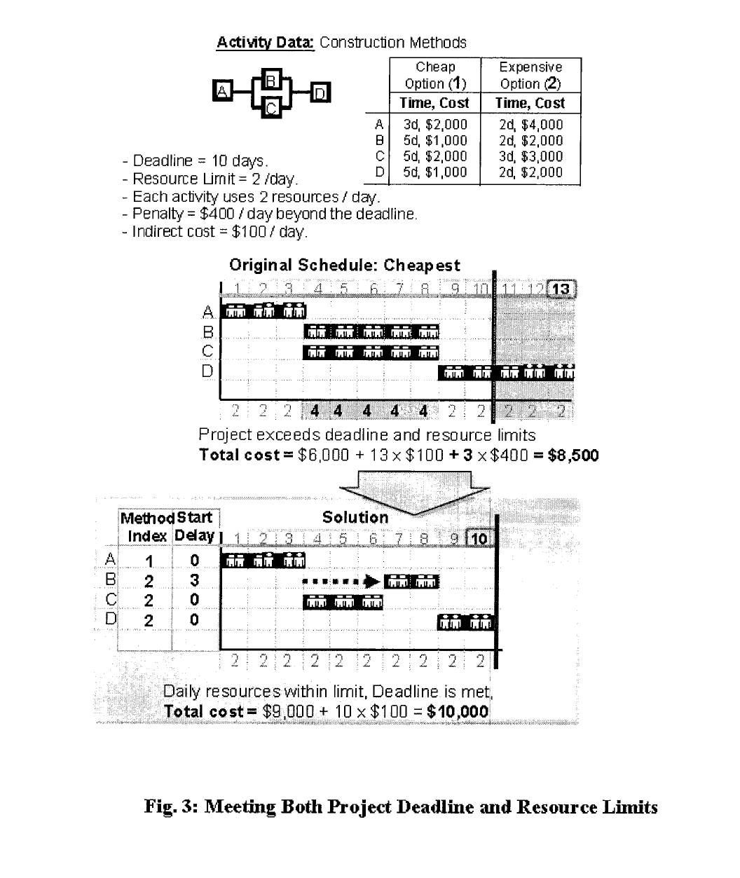

Another genetic algorithms approach that combines the CRS and TCT simplified representations of FIGS. 1 and 2 was introduced earlier by the inventor. The example in FIG. 3 shows that using a combination of the two activity variables (Method index and start delay) can resolve a combination of deadline and resource constraints. The challenge is to determine the proper values for the variables that produce a near optimum solution (i.e., meet deadline at lowest cost, without violating resource limits). More information about the use of GA tools to determine near-optimum values can be found in Hegazy, T. (2006) “Simplified Project Management for Construction Practitioners,” Cost Engineering Journal, AACE International, vol. 48, No. 11, pp. 20-28, and Hegazy, T. (2002). Computer-Based Construction Project Management. Prentice Hall, Upper Saddle River, N.J., USA.

Despite their benefits, metaheuristics such as genetic algorithm models, as mentioned earlier, have some difficulties related to their need of frequent parameter tuning and large computational time, thus making them suitable more for improving, rather than generating, a solution. To circumvent these problems and provide the ability to generate fast good solutions, the present disclosure introduces an efficient heuristic system and method which allows scheduling tools to incorporate both TCT and CRS concurrently or simultaneously. The proposed system and method can generate fast, practical, and near-optimal solution to schedule constraints, which can be readily used by professionals. The heuristic solution can also serve as a good starting point for further optimization, if needed.

### Integrated Heuristic Approach for Concurrent CRS and TCT Optimization

As mentioned earlier, CRS and TCT problems require two separate decisions (see FIG. 3): (a) the start-delay values that resolve resource over-allocations; and (b) the construction method indices that meet the project deadline constraint. These two activity variables represent important corrective action decisions during actual progress. For example, if a project is delayed, then a suitable corrective action is to modify the values for these variables. The proposed heuristic approach for integrated CRS and TCT, therefore, will heuristically determine proper values for these activity variables in response to the dynamic set of project constraints. To demonstrate the proposed method and offer it in a readily usable manner, Microsoft Project software has been used as an implementation media using its VBA programming. The proposed method is discussed next along the description of a case study.

The illustrative example in FIG. 3 is used to demonstrate the difference between the traditional way of sequentially applying existing CRS and TCT heuristics versus the proposed approach that combines CRS and TCT. The time and cost estimates for the activities in the case study are shown at the top of FIG. 3. The general project information indicates a strict 10-day deadline, a late penalty of $400 per day, a $100 per day indirect cost, and a strict resource limit of 2 per day. It should be noted that each activity has two estimates, which represent practical options that vary from slow and cheap (option 1) to fast and expensive (option 2). The fast and expensive estimates represent construction methods with more productive equipment/crews, working overtime hours, or outsourcing to a subcontractor.

In the case study, provided as an illustrative example, using the cheapest method (Option 1) for each activity without considering the resource limits, the project duration becomes 13 days (3 days beyond the deadline) with a total cost of $8,500 ($6,000 direct cost+$1,300 indirect cost+$1,200 penalty).

### Applying Traditional CRS and TCT Sequentially

In an attempt to manually meet the resource and deadline constraints, traditional approaches are applied one-after the other. First, the traditional manual CRS process (Hegazy 2002) was applied to this example, as illustrated in Table 1, below.

TABLE 1
Manual CRS calculation

| | Current | | | | | | |
|---|---|---|---|---|---|---|---|
| | Time | Eligible | Resource | Duration | | Activity | Activity |
| Cycle | (CT) | Activities | Needs | (D) | Decision | Start (ST) | Finish (FT) |
| 1^{st} | 0 | A | 2 | 3 | Start A on CT (0) | 0 | ST + D = 3 |
| 2^{nd} | 3 | B | 2 | 5 | Start B on CT (3) | 3 | 8 |
| | | C | 2 | 5 | Delay C to next | N/A | N/A |
| | | | | | CT | | |
| | | | | | (not enough | | |
| | | | | | resources) | | |
| 3^{rd} | 8 | C | 2 | 5 | Start C on CT (8) | 4 | 13 |
| 4^{th} | 13 | D | 2 | 5 | Start D on CT | 13 | 18 |
| | | | | | (13) | | |

Notes:
Resource limit = 2/day.
Final project duration is 18 days.
From the table, only activity C has a start delay of 5 days.

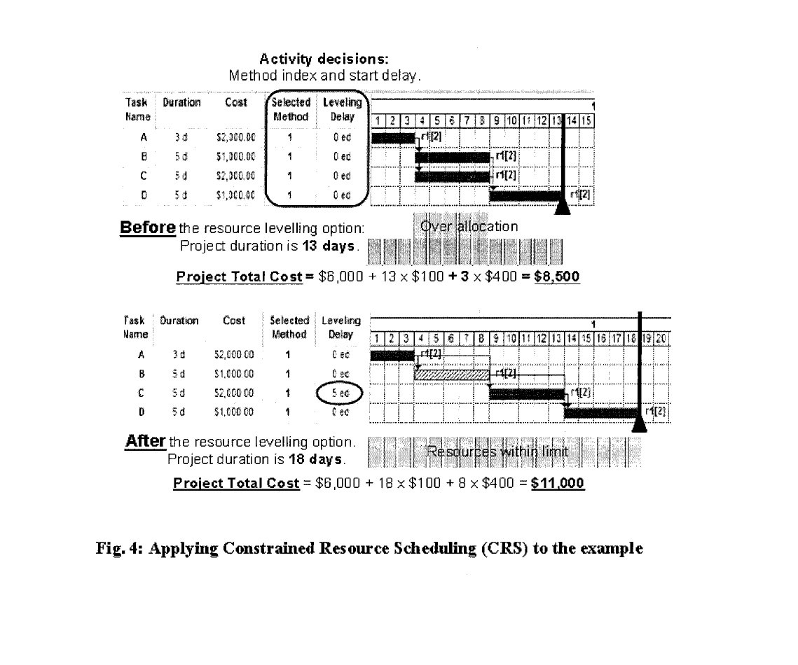

The process follows the logical relationships to schedule the activities considering their resource needs and the daily resource limit, in four cycles, as shown in the table. In the first cycle (current time=0), activity A was scheduled. The next cycle then has a current time equal to the finish time of A (i.e., the resource will be released at that time). In the second cycle, both activities B and C become eligible (both follow A) but the resource limit makes only B possible to start at that current time (day 3) and finish on day 8 (the current time of next cycle), while activity C is delayed. In this cycle, activity B was assumed to have higher priority than C (many rules can be set to assigned priority such as smallest total float (Hegazy 2002)). Upon completing the process, the resulting resource-loaded schedule indicates that the project duration is extended from 13 days to 18 days. Applying the CRS on the same example on Microsoft Project (through the resource leveling option of the software) is shown in FIG. 4. The figure shows that the CRS solution was obtained by introducing 5 days of start delay to activity C to resolve the over-allocation. The project total cost also increased from $8,500 to $11,000 (FIG. 4).

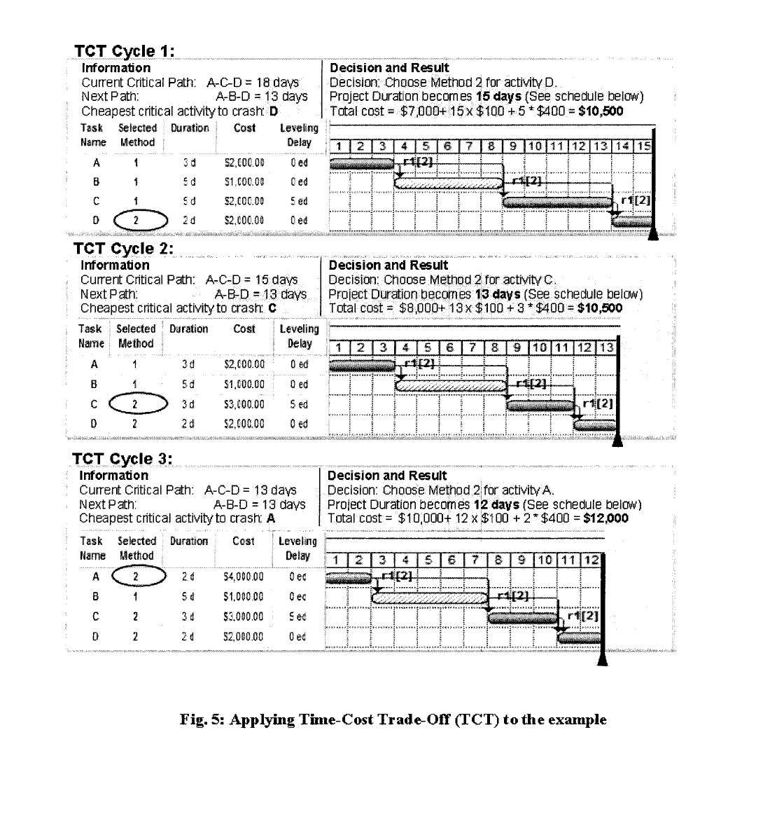

With the resource limits resolved, as a first step, the next step involves trying to reduce the project duration from its 18 days to meet the deadline (10 days) using traditional TCT analysis. The analysis (Hegazy 2002) is applied in cycles, as shown in FIG. 5, where in each cycle, the critical activities are focused upon and the one(s) that can be crashed with lowest increase in cost is selected. Accordingly, the construction method associated with the selected critical activity is changed to a faster alternative. In this process, resource limits are not observed.

As shown in FIG. 5, the first cycle reduces project duration to 15 days, with the project total cost becoming $10,500. Following the three cycles in FIG. 5, all critical activities are now crashed and the project duration becomes 12 days (2 days beyond the deadline) with a total cost of $12,000. The solution does not improve beyond this result. Even if project deadline is met, in larger projects, it is likely that the resources will be over allocated, which will then mandate another round of CRS resolution, then another round of TCT again, yet without guarantee that a solution that resolves both issues combined will emerge.

### Applying the Proposed Combined CRS and TCT Method

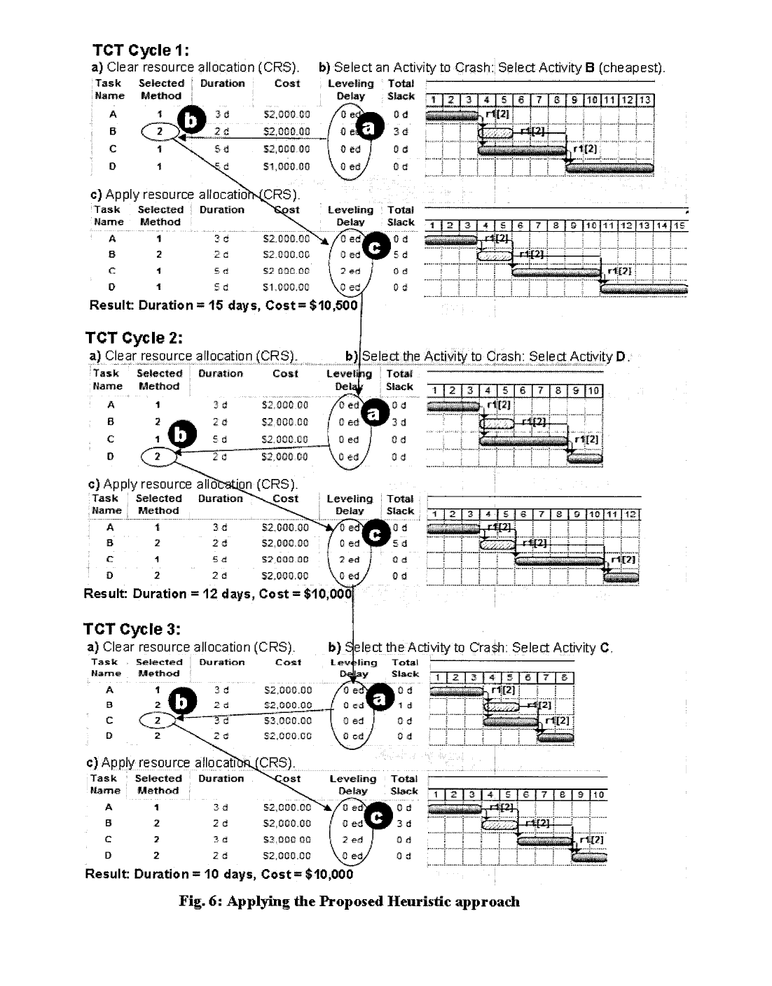

Starting from the initial schedule of 13 days (top part of FIG. 4), which is the cheapest but longest project duration, the application of the proposed method to the case study is shown in FIG. 6. The solution involved three TCT cycles, where three sequential steps are carried out within each cycle: (a) the resource allocation (CRS) is cleared (i.e., start delays are put to zeroes); (b) select the cheapest activity to be crashed, thus incrementally decreasing project duration; and (c) applying CRS to resolve the resource over allocation associated with current schedule. Since the last step may extend project duration beyond the deadline, the process then repeats the cycle until the lowest-cost project duration that meets resource limits is arrived at or no more activity crashing can be done. Since the process takes into account the liquidated damages for delays beyond the deadline and also the bonus for early completion, minimizing total project cost becomes a good quantitative measure to be used as a stop criterion for the process.

Following the above process for the case study, the decisions associated with the three steps a, b, and c of each cycle are circled in FIG. 6, and the resulting changes to the schedule are shown. In cycle 1, when activity B is crashed, the project duration remains 13 then extended to 15 after CRS is applied. In cycle 2, activity D was also crashed (activity B is still crashed), thus the project duration becomes 10, which is extended to 12 after CRS is applied. In cycle 3, the project duration reduces to 8 days after crashing activity C, afterwards extended to 10 after applying CRS. At this stage, both deadline and resource limits are met and the total project cost is $10,000, thus the process stops.

This small example demonstrates the ability of the proposed approach to arrive at the low-cost plan, while meeting both deadline and resource limits. Comparing the traditional sequential approach of FIG. 5 and the proposed approach of FIG. 6, both approaches involved three TCT cycles but with different results. The main difference between the two approaches is that in the proposed approach, CRS (and its resulting set of start-delay values) is calculated within each TCT cycle.

### Detailed Procedure and Implementation

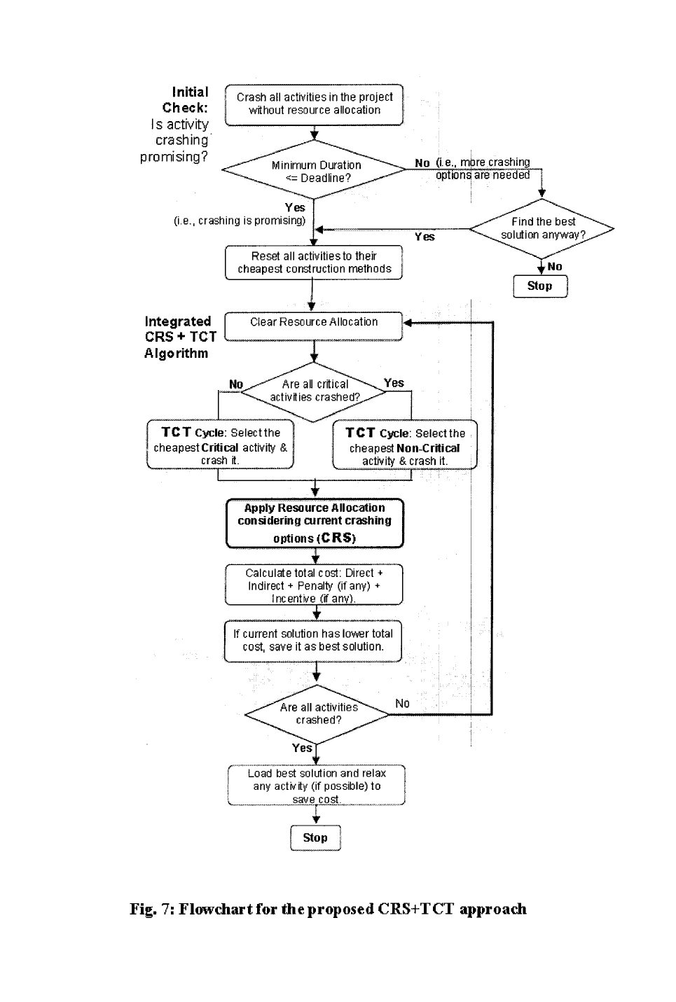

A detailed flow chart of the proposed combined CRS and TCT heuristic approach is presented in FIG. 7. At the beginning of the process (top part of FIG. 7), an initial check is carried out to examine if a solution exists for the existing project constraints. In this step, all the project activities are setup to use their fastest construction methods (most expensive). The resulting project duration (expected to be the shortest possible) is then compared to the deadline to check whether this minimum project duration satisfies the deadline constraint. If it cannot meet the deadline, the user is notified that even with all activities crashed, the deadline will not be met (i.e., a solution does not exist) and that more crashing options are needed. The user can then stop the process and add more activity options, or simply proceed to find the best possible solution anyway.

After passing the preliminary check, the combined CRS and TCT process starts by resetting the activities to their cheapest options (longest project duration), then proceeds with the crashing cycles until no more crashing can be done. At the earlier cycles, the cheapest critical activities are crashed one-by-one to reduce the critical path. When in any cycle all critical activities are found to be crashed, the algorithm then starts crashing the cheapest non-critical activity to avoid process stagnation. Along this process, CRS is used at the end of each cycle to meet resource limits. As such, each cycle provides one feasible project duration (and cost) that does not violate resource limits. The best solution (cheapest total cost) from any cycle and its associated values of start delays and construction methods is then saved. The total cost calculation within each cycle considers all the direct costs of the methods, in addition to total indirect costs, penalty for longer project duration beyond the deadline, and incentive for shorter project duration.

Before presenting the result to the user, the best solution is then examined and a process of relaxing crashed activities is followed (bottom part of FIG. 7). In this process, each crashed activity at a time is considered and a cheaper method is tried (e.g., method 3 becomes 2, etc.) and total cost is examined. If total cost is reduced or remained the same, the relaxed method is retained; otherwise the crashed method is retained. Upon examining all the crashed activities and making final adjustments, the final solution is presented to the user. It is noted that it is possible to apply this relaxation at the end of each cycle rather than at the end of the whole process. This may improve the overall result, however, at the expense of a much longer processing time.

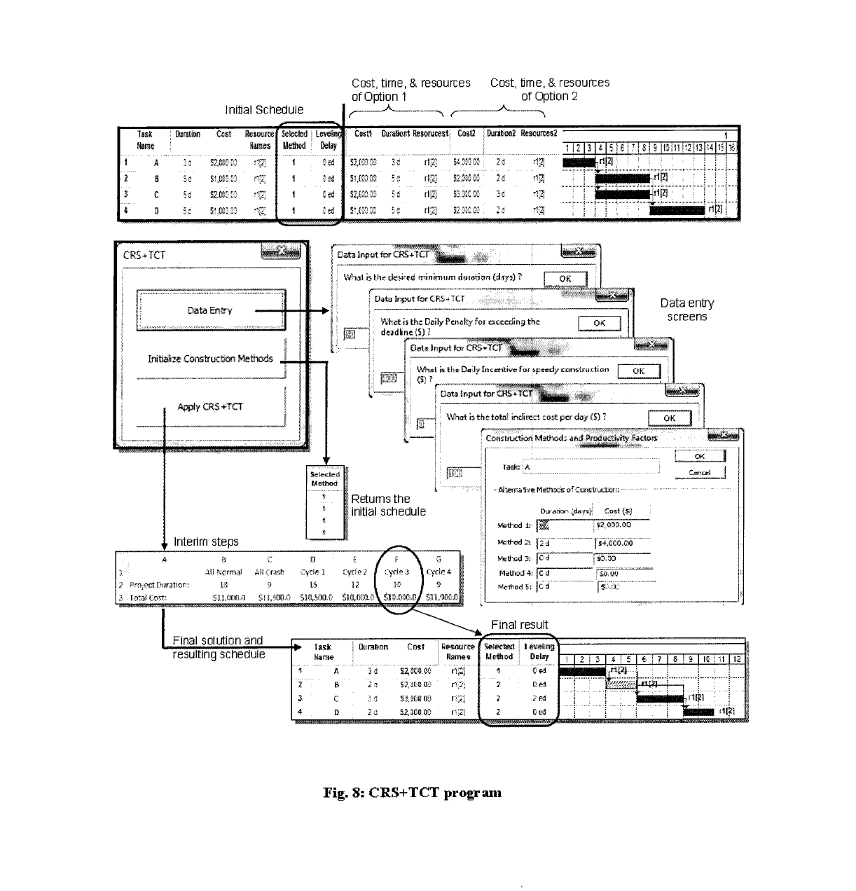

Using the macro language of Microsoft Project, the proposed procedure was coded in a simple application to automate the combined CRS and TCT analysis. The developed application is shown in FIG. 8 (available for download as mentioned earlier) with input screens for entering the project data, including up to 5 methods of construction for each activity. The benefits of implementing the application as an add-in to an existing software include: (1) the application readily utilizes the network diagramming, Gantt chart, relationships, reporting, and resource leveling (CRS) engine of the software, without need to program independent ones; (2) the application can work for any size project since it automatically detects the number of activities in the project; (3) the application can work for any number of resource constraints since it automatically detects the number of resources in the project and their availability profiles which can be time-dependent; (4) the application uses the calendar system of the software and automatically determines activities' start and finish dates considering vacations, etc.; and (5) the application is flexible in allowing the activities to use different combinations of resources for the construction methods. Due to these benefits, the application is readily usable for real projects as a decision support tool for handling project constraints.

Comparison with GA Optimization

The combined CRS and TCT system and method has been tested on different case studies with different numbers of activities and proved to work consistently. To examine its performance, its results were compared to those of three literature case studies that used genetic algorithms (GA) to optimize TCT and CRS decisions (Leu and Yang 1999; Senouci and Eldin 2004; and Chen and Weng 2009). The authors could not find case studies in the literature that apply exact mathematical optimization incorporating both TCT and CRS decisions. For the experimented cases, the comparison of results in Table 2, below shows the good performance of the proposed heuristic solution (close but lower performance than GAs is expected).

TABLE 2
Comparison between the proposed heuristic method and existing research

| | | | Results of | |
|---|---|---|---|---|
| | Case Study | Results of GA | Proposed | |
| Research | Description | Optimization | Algorithm | Comments |
| Leu and | Nine activities having | Project cost = | Project cost = | Identical |
| Yang | up to 5 discrete options | $7,400. | $7,400. | results. |
| (1999) | that use varying | Project duration = 64 | Project duration = | |
| | amounts of three limited | days. | 64 days. | |
| | resources. | | | |
| Senouci | Eleven activities having | Project cost = | Project cost = | Difference in |
| and Eldin | continuous time-cost | $102,675. | $106,125. | results is partly |
| (2004) | relations and use | Project duration = 18 | Project duration = | due to the fact |
| | varying amounts of | days. | 20 days. | that the |
| | three limited resources. | | | proposed |
| | Also, activities have | | | algorithm only |
| | many complex FF, SS, | | | uses discrete |
| | SF relations with lags. | | | methods. |
| Chen and | Ten activities having up | Project cost = | Project cost = | Close cost. |
| Weng | to 4 discrete options that | $244,000. | $245,900. | Duration is |
| (2009) | use varying amounts of | Project duration = 56 | Project duration = | longer since no |
| | one limited resource. | days. | 59 days. | penalty for |
| | | | | delays beyond a |
| | | | | deadline is used |
| | | | | in this example. |

Based on these results, the advantages and shortcomings of the proposed heuristic method as compared to GA optimization research are highlighted in Table 3, below.

TABLE 3
Advantages and shortcomings of the proposed heuristic method

| Item | Metaheuristics (e.g., GA optimization) | Proposed Heuristic Method |
|---|---|---|
| Advantages | Near optimum result | Follows a simple logical and explainable |
| | Extensive search of the solution space | process |
| | Results can be used to generate a Pareto | Results are repeatable |
| | front | Fast processing time for small/medium |
| | | projects |
| | | Does not require parameter tuning |
| | | Can provide a fast initial solution to GA |
| | | models |
| | | Redoing the analysis during project |
| | | control causes less disturbance to the |
| | | original schedule |
| Shortcomings | Models are difficult to formulate | Results may not be optimum |
| | Results are randomly generated (not | |
| | repeatable) | |
| | Very Long processing time | |
| | Results may not be optimum | |
| | Requires problem-specific parameter | |
| | tuning | |
| | Re-optimization disturbs the original | |
| | schedule | |

The key advantages of the proposed heuristic method are its simple logic and fast repeatable results. To meet both a deadline and resource constraints, the algorithm basically “Carries out step-by-step crashing of cheapest critical activities while resolving resource constraints in each step”. This is opposed to the completely random nature of GA models. As such, the proposed algorithm can also provide a good initial solution to GA models, thus improving the likelihood of getting a better solution faster.

In terms of processing time performance, the proposed add-in application takes about 2 seconds, 11 seconds, 46 seconds, 4 minutes, and 32 minutes to process case studies with 9, 45, 90, 180, and 360 activities, respectively on a laptop machine with 1.6 GHz processor speed. This processing time is much faster than any GA process. Chen and Weng (2009), for example, reported GA processing time of 8 minutes for their 10-activity case study (comparable to 2-seconds of the proposed algorithm). Kandil and El-Rayer (2005) also reported GA processing time of 55 hours for a case study of 360 activities, which is reduced to 9.3 hours using a system of parallel computing with 50 processors. In comparison with these efforts, the processing speed of the proposed heuristic approach is tremendously much faster, thus being practical and suitable for larger projects. The processing speed can also be much further improved by re-writing the existing rudimentary algorithm using a faster programming language and using a faster hardware. The combination of solution quality and processing time performance of the proposed algorithm, therefore, serve as a proof-of-concept and should motivate the developers of existing software systems to implement such an algorithm, particularly since the algorithm does not require any problem-specific tuning of any parameters.

Additional improvements to the proposed method are currently being experimented with by the authors to improve the performance of the proposed procedure and its application, including: extensive testing on real-life projects; using the results of the proposed heuristic approach as an initial solution to GA optimization models; experimenting with the algorithm in a multi-project setting; experimenting with the algorithm for project control and corrective action purposes; and experimenting with multi-skilled resources to improve the results.

### Simplified IT Tools for Site Information Tracking

In another aspect, to improve the tracking of site information, this disclosure proposes a voice/visual approach for communicating among project participants and collecting daily site information. The disclosure discusses the cost-effective information technology (IT) tools such as email, internet-based telephony, SMS (Short Message Service) that are available commercially at low-cost. The disclosure then proposes a framework for site information collection that combines these IT tools with a scheduling system. In an embodiment, the framework can be implemented on a handheld device that allows both voice and visual communication and documentation. This system has the ability to capture all daily site information related to each activity along with supporting documents (photos, video, audio, as-built sketches, and other documents). As such, it helps in thoroughly and effortlessly documenting the evolution of the construction progress and its as-built outcome. The proposed system allows construction firms better control over construction operations and provides timely data for decision making, which can lead to better productivity and fewer disputes.

Construction is one of the world's largest industries and contributes to about 10% of the gross national product (GNP) in industrialized countries (Allmon et al. 2000). Any improvement in its performance therefore will have a significant economic impact. Despite being large, many researchers (e.g., Moura and Texeira 2006; Ghanem 2007) have reported that the construction industry suffers from low productivity, high accident rate, cost overruns, delays, and poor quality. One of the greatest challenges facing construction managers in controlling projects is to keep track of all action that takes place on site in order to facilitate performance analysis, detect potential problems, and select appropriate corrective actions (Wang et al. 2007; Russell et al. 2009). Such tracking, however, is not simple because construction projects involve large amounts of information related to a variety of functions, such as scheduling, construction methods, cost management, resources, quality control, and change order management. The sheer volume of construction information comes from different sources and in different forms (Korde 2005). Such information is often unclear and not properly documented, thus contributing to misunderstandings, incorrect assessments of project performance, and lack of early warnings.

Until recently, on-site progress data collection has been paper-based, which is inefficient even for small projects and has been recognized as one of the major problems that cause project delays and cost overruns (Gajamani and Varghese 2007). Paper-based data collection is slow, inaccurate, incomplete, time consuming, and labor intensive (Davidson and Skibniewski 1995; McCullouch (1997); Navon 2005; Reinhardt et al. 2004; Trupp et al. 2004; Navon and Sacks 2007). These limitations cause project managers and their teams to spend most of their time dealing with secondary issues or solving the wrong problems (Navon and Sacks 2007). A study conducted by McCullouch (1997) revealed that 30-50% of the field supervisory personnel's time is spent on recording and analyzing field data.

Recently, a number of information technology (IT) tools have become affordable and can be used to collect data in a variety of formats, including text messages, pictures, voice, and video. Such tools can be used to provide timely and accurate data to support project control (Hwang et al. 2003), and enhancing the communication and coordination among project participants (Wang et al. 2007).

This disclosure introduces an early effort towards developing an automated data collection system based on available voice/visual technologies to provide users with a simplified yet efficient mechanism for accurately tracking construction progress and for recording all daily site events throughout the execution of projects.

### Voice/Visual Site Information Tracking Framework

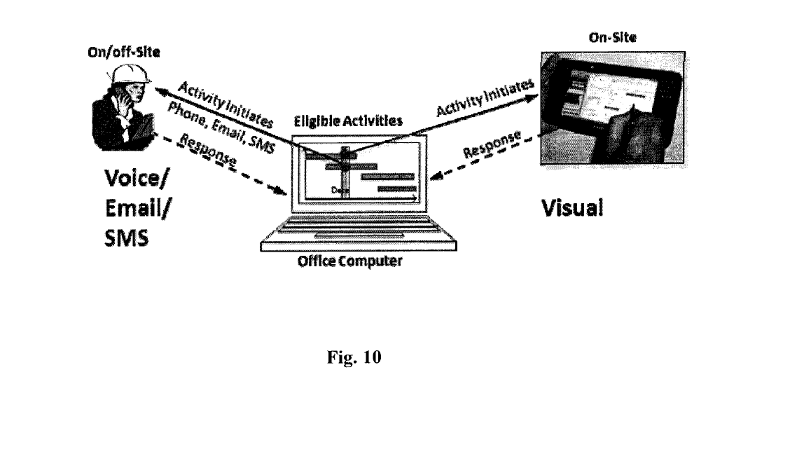

The proposed framework will combine email, internet-based telephony, and visualization tools into a single framework to send and receive activities' information so that the project schedule can be automatically updated, as-built information recorded, and corrective actions facilitated. The framework is illustrated in FIG. 10.

To enable the development of the proposed voice/visual framework for tracking daily site information, this research involves three main aspects, as follows: Collect and analyze previous construction data to develop better understanding of the data collection needs of construction activities and to identify their most suitable proper approach for tracking site information (visual, voice, email, etc.); Develop an integrated framework for tracking site information using a variety of voice/visual tools; Validate and test the framework using real case studies.

### Data Collection and Analysis

To identify possible site events related to each activity, an in-depth survey of construction experts will be conducted to obtain information about the progress tracking needs for each activity and to identify the best approach(es) for tracking site information; the appropriate frequency for tracking each activity; and the effective method of documenting the activity events. The survey will be carried out on two phases: Phase I to Identify possible site events, and Phase II to generate and revise various progress tracking scenarios.

Phase I Survey: To enable the design of a survey about site data, useful information was found in the literature about the categories of site information. For example, Scott and Assadi (1999) used the following three categories: finance, quality, and progress. De La Garza and Howitt (1998), on the other hand, used the following ten categories: jobsite record keeping, request for information, schedule and methods, quality control/assurance, safety, submittals, material management, equipment management, cost management, and future trends. Combining the benefits of these efforts, this research considers the following six categories of activity-related information, as shown in the preliminary survey form in Table 4, below:

TABLE 4
Survey Form for Obtaining Activity Tracking Requirements

| | Documentation Tools | | | | Documentation |
|---|---|---|---|---|---|
| Information Type | Email | Phone | SMS | Visual | Type * |
| Category 1. General | | | | | |
| Technology | | | | | |
| Location (GPS coordinates, etc.) | | | | | |
| Drawings | — | — | — | — | — |
| Parent level in the OBS | | | | | |
| Category 2. Constraints/Requirements | | | | | |
| Constraints | □ | □ | □ | □ | — |
| Other requirements | □ | □ | □ | □ | |
| Category 3. Progress Measurement | | | | | |
| □Units complete | □ | □ | □ | □ | |
| □Start/finish | □ | □ | □ | □ | |
| □Supervisory opinion | □ | □ | □ | □ | |
| [symbol] Milestone | [symbol] | [symbol] | □ | □ | |
| □Cost ratio | □ | □ | □ | □ | |
| □Level of effort | □ | □ | □ | □ | |
| Category 4. Site Events | | | | | |
| □Progress amount | | | | | |
| □Owner events? | | | | | |
| Approval delay? | □ | □ | □ | □ | |
| Change orders? | □ | □ | □ | □ | |
| Other | □ | □ | □ | □ | |
| □Contractor events? | | | | | |
| Equipment failure? | □ | □ | □ | □ | |
| Rework? | □ | □ | □ | □ | |
| Acceleration? | □ | □ | □ | □ | |
| Other | □ | □ | □ | □ | |
| □Neither event? | | | | | |
| Bad weather | □ | □ | □ | □ | |
| Other | □ | □ | □ | □ | |
| Category 5. Quality Control | | | | | |
| Quality control task? | □ | □ | □ | □ | |
| Frequency? | □ | □ | □ | □ | |
| Requirements? | □ | □ | □ | □ | |
| Category 6. Resource/Productivity Data | | | | | |
| Labour absence | □ | □ | □ | □ | |
| Labour overtime | □ | □ | □ | □ | |
| Sensitive resource | □ | □ | □ | □ | |
| Others | □ | □ | □ | □ | |

*Documentation Type: photo, video, CAD, memo, email, etc.

The first three categories represent general activity information that will be used to set up the tracking of site information. The second three categories represent information that will be collected during the actual progress of the activity. The six categories of activity information allow all possible site events for an activity to be recorded. The survey form also collects activity-specific information related to the suitability of various IT tools. It should be noted that, to save time and effort, a single survey form may be used for some groups of activities that involve the same information, For example, concreting activities for columns, beams, slabs, foundation, etc., share almost identical information except for minor differences, which will be highlighted during the interviews with expert professionals.

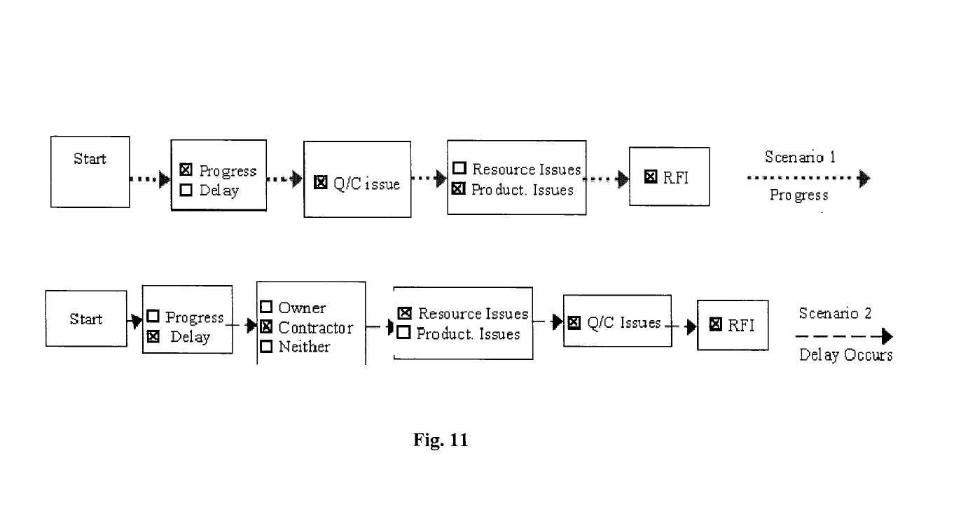

Data Analysis: Once the survey responses are received, the data will be analyzed. After all the activity's data is collected, an extensive analysis will be carried out to identify the logical flow of tracking information for each activity and to generate scenarios of possible daily events. For example, two sample information flow scenarios for daily events in pavement construction are shown in FIG. 11.

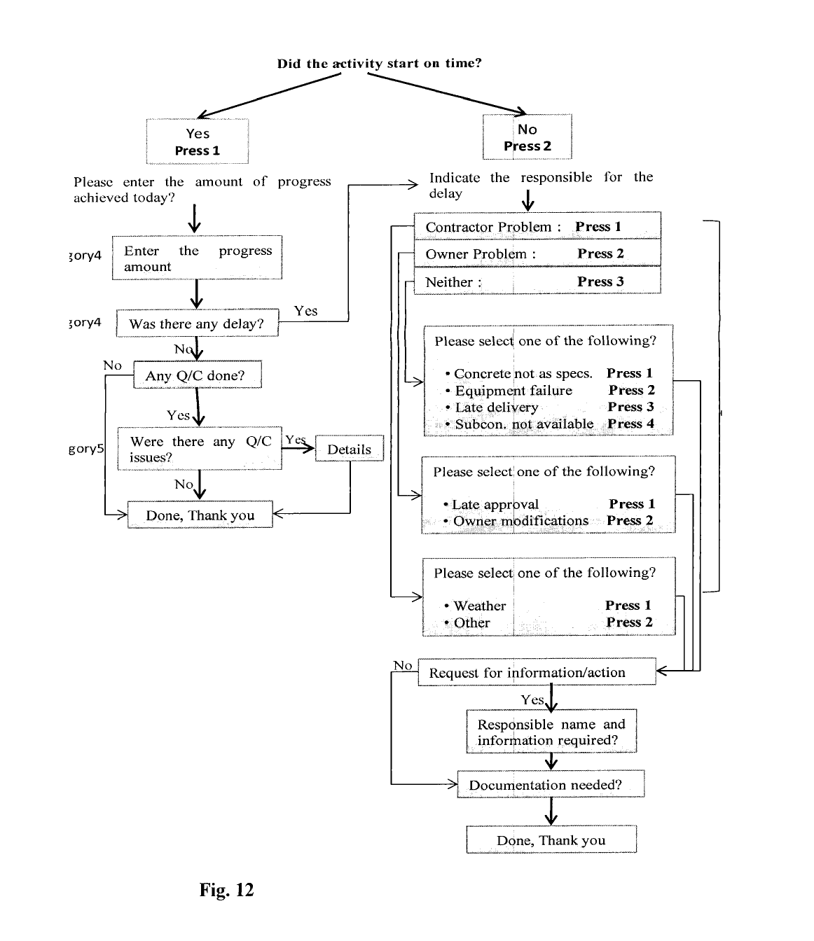

Phase II Survey: After compiling possible tracking scenarios and their suggested data collection scenarios, a second survey will be carried out to verify the practicality of the proposed tracking flow and to indicate changes. The scenarios can be discussed during interviews in order to define the best flow to be used for each communication tool (email, phone, SMS, etc.). During these interviews, the final flowchart for each activity (or group of activities) will be finalized for integration into the proposed site information collection system. The call flow diagram shown in FIG. 12 is an example of a set of questions that can be programmed in a voice call, email, etc. for obtaining complete site information from supervisory personnel about a pavement construction work. For example, on a specific date, the asphalt layer was supposed to start and the planned daily progress was expected to be about 15%. On that date, the system would automatically generate a communication with the supervisor using the flow in FIG. 12, which dynamically changes the set of questions in response to the user's answers. For example, if the respondent presses 1 as a response to the first question to indicate some progress, the next set of questions shown in the left-side branch will follow. If the respondent press 2 to indicate a delay (work stop), the system will follow the set of questions shown in the right-side branch. From the sequence of buttons pressed, the system will record the daily progress, the reasons for delays, and other site events.

### An Example of a Voice Data Collection

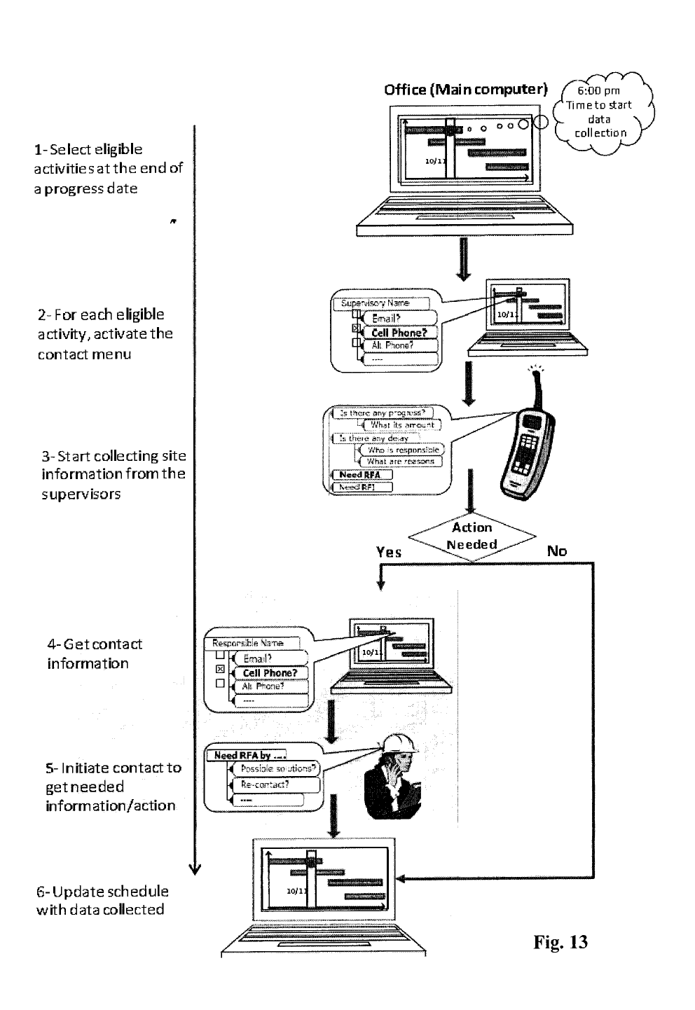

The following example illustrates how the voice-based component of the proposed framework will be used to collect site information using multilevel dynamic interactions. According to the planned schedule, the asphalt layer activity for a simple road project was planned to start on November 10th. Assuming that the flow chart of progress tracking for this activity is as shown in FIG. 12, at the end of the progress date (i.e., 6:00 pm), the system starts the tracking process following the flow shown in FIG. 13. First, the eligible activity is defined, then the supervisory contact information associated with it (name, email address, cell phone number, alternative phone number, etc.) is retrieved. The contact method that has the highest priority is then used to collect the progress information on that date. In the case of no progress, the supervisor will be asked about the party responsible for the delay, the reasons for the delay, and the supporting documents. If the supervisor requests a request for action (RFA) or information (RFI), the system automatically initiates a new call to the person responsible for responding to this request.

The proposed framework thus works as a multilevel interactive voice response (IVR) system that provides timely information and helps managers to decide timely solutions to emergent problems. A notification message can also be issued when the response is received. In addition to voice-based communication, the system will also allow the supervisor to use a hand-held device to visually highlight the location of the constructed elements on digital images (or the 2D/3D CAD drawings) associated with the project. This approach is highly effective for visually identifying the elements that have been completed to-date along with pictures, sound, etc. Accordingly, they will be used to automate the development of as-built information. Decision makers will thus have access to complete information about the evolution of the construction progress, which facilitate effective analysis of project delays and disputes.

After collecting all site events including progress data, the system automatically updates the project schedule. Updating the project schedule is followed by comparing the variance between the planned and the as-built schedule in order to determine the variations. In the case of a major variance, the system automatically starts another communication (e.g., email, phone, SMS, etc.) to the activity supervisor in order to verify the previously collected data and to re-confirm the schedule information. Based on the updated information, the framework produces various progress reports for viewing by project participants.

This disclosure targets the development of a simplified framework to automate daily site information tracking using voice and visual IT tools. First, a survey approach is being prepared to better understand activities' progress tracking needs. Based on the survey, a number of scenarios for daily site events related to each activity will be generated and used to design the flow of questions within an automated voice response system for site information tracing. A simple example for applying such a voice-based framework for collecting daily site information for construction project has been presented in this disclosure to demonstrate the proposed concept. The authors are currently working on data collection and analysis which will be followed by prototype development and validation through real case studies to check the applicability of this system in a construction firm. While its real applicability is yet to be tested, the proposed framework has the potential to minimize the time and cost associated with site data collection, schedule updating, report generation, and initiation of warning signs. In addition, it also has a great potential for automating the generation of accurate as-built information based on a comprehensive representation of all the steps throughout the evolution of the construction process. Such system is expected to help construction firms to better control construction operations and provide timely data for decision making. It will also contribute to automation efforts in the construction industry, which can lead to better productivity and fewer disputes.

### Email-Based System for Documenting Construction As-Built Details

In another aspect, this disclosure proposes a low-cost framework that utilizes prevailing communication tools (email) to develop a project-wide system for progress tracking and bidirectional communication between project participants and head office. The framework integrates three main components: email forms for site data collection; customized scheduling application; and customized email application. In the schedule, the activities automatically initiate email requests for as-built information using an email form that has a checklist of possible site events and enables supervisors to attach notes and any requests for information. On a daily basis, the system automatically reads the supervisors' response emails and updates the schedule with all recorded as-built details. The disclosure discusses the development of a prototype system and demonstrates its usefulness on a small bridge-pier foundation example.

As-built information plays an important role in performance analysis, corrective action planning, and later operation and maintenance of projects [1; 2]. The sheer volume of as-built information, however, comes from different sources and in different forms [3] such as schedules, construction methods, cost data, resources, quality control data, written and verbal communications, daily progress and site events, and change orders. Such information is often unclear and not properly documented, thus contributing to misunderstandings, incorrect assessment of project performance, and lack of early warnings.

Until recently, on-site progress data collection has been mainly disclosure-based, which has been reported as one of the major problems that cause project delays and cost overruns [4]. Manual methods are slow, inaccurate, incomplete, time consuming, and labor intensive [5; 6]. These limitations deviate the managers and their teams from solving actual problems and force them to spend most of their time dealing with secondary issues [7;8]. The study of McCulloutch [7], for example, reported that 30-50% of field supervisors' time is spent on recording and analyzing field data.

In view of the challenges related to site information tracking, researchers have examined various site data collection technologies (for progress tracking or field inspection) that range from low-end (disclosure-based) to high-end (e.g., sensing technologies, etc., as discussed later). Efforts that improve the traditional disclosure-based processes [9;10] aim at easing the manual work involved, as shown in Table 5, below.

TABLE 5
Comparison of available site data collection technologies.

| | Technology | | |
|---|---|---|---|
| | Low-End | High-Potential | High-End |
| | Manual/ | Multimedia, Voice, | Sesing Technology, 3D |
| Function | Paper-based | Phone, Email, etc. | Laser Scanning, etc. |
| Communication with Site | All Manual | All Automated in the | Under development by |
| Tracking Daily Progress | Functions | Proposed System | many researchers |
| Schedule Updates | | | Currently very |
| Progress Analysis | | | expensive |
| Attach Site Events to Activities | | | Not coverged in this |
| Attach Documents to Schedule | | | research |
| Respond to RFIs | | | |
| Applies to | Small Projects | Small/Medium Projects | All Projects |

In between the low-end and high-end tools is group of affordable and high-potential tools that include multimedia [11], information and communication technologies such as voice and wireless [12; 13; 14; 15], hand-held tools [16; 17], and web-based tools [18; 19]. Many of these efforts served to mainly demonstrate the potential benefits of the tools, however, most efforts did not offer a project-wide automated solution for project control. The use of multimedia, for example, has been proposed since 1990 to improve data collection for delay analysis purposes [11] by recording video files as attachments to the activities in the schedule. While this is useful, it is still up to site personnel to find the time and effort to collect this information and link it to the schedule. Also, utilizing this information (e.g., understanding the percentage complete from a video) is still a manual process.

In addition to multimedia, various low-cost and high-potential IT tools have become common place, including Interactive Voice Response (IVR) systems, email service, and Short Message Service (SMS). These technologies have great potential for collecting and sharing site information in a timely manner. IVR is an efficient tool that can be used in a voice-based system to enable interaction with the user to automatically input information into the system by voice. Also, it can be used to access information from computer systems efficiently [13; 14]. Email, on the other hand, has also become a popular form of data collection, exchange, and sharing [20]. In general, email is the most economical mean to send and receive mail in a fast way. Using email for collecting and tracking construction site information, therefore, is not only efficient but also cost-effective and has no geographical barriers. Because of its availability, affordability, and great potential, email has been utilized in this research and will be extended in the future to include IVR.

Recently, several high-end technologies (e.g., barcoding, RFID sensors, 3D Laser scanning, photograinmetry, GPS) have been examined in the literature for monitoring progress in real-time; tracking labor productivity; and tracking materials and equipment. Barcoding and radio frequency identification (RFID), for example, have been used to track the locations of resources [21; 22; 23; 24]. Image recognition and 3D laser scanning have been used to track the quantities of work performed on site [6; 25; 26]. Photogrammetry has also been integrated with other tools such as 3D laser scanning [27] to extract 3D data from 2D progress images. With their high automation potential, continued research on these high-end tools is expected to reduce their future cost of implementation in projects.

With the potential of low-cost IT tools (email and electronic messaging) clearly demonstrated in the literature, this research aims at integrating such technology into a project-wide communication and documentation system that automates the manual functions in Table 5. This includes full documentation of the as-built evolution as well as facilitating corrective action decisions and schedule analysis.

### Level of Detail in As-Built Information

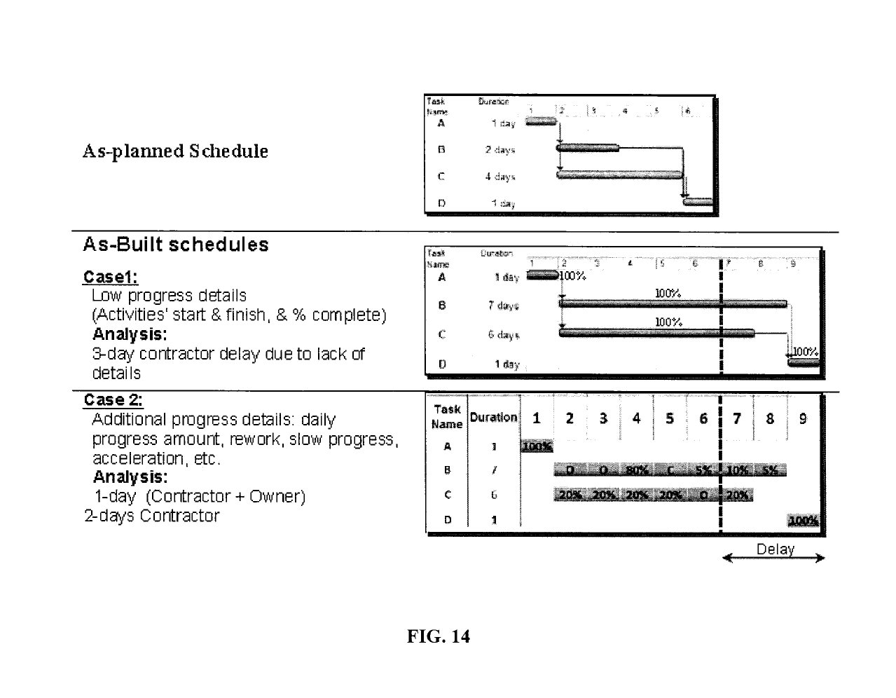

The project manager's ability to decide on appropriate corrective actions or to do forensic schedule analysis requires enough details on how progress events of all parties have evolved, including work stops, acceleration, rework, etc. In order to introduce realistic and practical support for project control, it is important to examine the level of as-built detail at which project control decisions can be efficiently done. Basically, an additional level of detail will only be necessary if such detail will directly impact project control decisions. Examining different level of project as-built details can be demonstrated by the example in FIG. 14. The figure shows the as-planned schedule for a simple 4-activity case, against two cases of as-built details. The as-planned duration is six days (the top path has two days of total float), while the as-built duration is nine days (the top path became critical), with project delay being three days. Brief explanation of the two cases and the analysis of their as-built schedules follow.

Case 1: shows a typical representation of progress as provided by existing commercial software. This as-built schedule can be deterthined using least amount of information which is the actual start and actual finish times of each activity (percentage complete is 100%). Such level of information does not describe the party responsible or the reason behind any daily interruption. Accordingly, due to the lack of details, the responsibility for the three-day project delay is allocated as sole contractor responsibility.

Case 2: shows the same 9-day as-built schedule but with an extra level of detail for the daily as-built events, where some owner and contractor interruptions are indicated on the schedule (an 0 indicates owner; and C indicates contractor). Daily progress amounts are also shown (e.g., acceleration to activity B on day 4 and slow progress on days 6 to 8). In this situation, starting from the as-planned schedule, daily events of case 2 are imposed and analyzed. The two “0” interruptions on activity B (days 2 and 3)consume its two float days. Accordingly, two critical paths exist as per the events at the end of day 3. Afterwards, the 80% progress, which represents accelerated performance, created a one-day float on the top path as activity B is expected to finish earlier. This float, however, is consumed by the contractor's interruption in day 5, thus having two critical paths again. Afterwards, the analysis proceeds to day 6 where both the owner and the contractor delayed the project one day. Further progress also delayed the project another two days due to slow contractor work. The resulting responsibility for the project delays are (1 day “C+O” and 2 days “C”).

In order to do the schedule analysis for case 2, the daily windows analysis of [28] has been used, which requires as-built information to be recorded on a daily basis. In comparison with case 1, the result (responsibility for the two days project delay) proved to be sensitive to the level of detail, which clearly indicates that using a lower level of detail will end up with wrong forensic analysis and consequently wrong corrective actions. As such, the proposed framework for progress tracking will allow data to be collected at the daily level.

### Activity-Specific Site Events

First step towards developing an automated site information tracking framework is to have a good understanding of the tracking needs of various activities. Focusing on highway projects, sample daily as-built forms were first analyzed and a comprehensive literature analysis among related references [e.g., 29; 30; 31; 32] was carried out. Table 6, below, summarizes the literature information, including activity-specific site events related to Owner, Contractor, and neither (i.e., third part); measurement unit; and any activity-specific considerations.

TABLE 6
Tracking needs of highway construction activities

| Activity | Possible | | Progress | Special |
|---|---|---|---|---|
| Name | Interruptions | | Measurement | Consideration |
| Mobilization | O: | 1—Delay in site handover or access | Lump Sum | Precautions to protect existing |
| | * | 1—Delay in material/equipment delivery | | facilities |
| | C: | 2—Delay in obtaining Permits | | Safety for users (Barriers, Signs, |
| | * | 1—Bad weather | | Lights) |
| | N: | | | Notify the local police, fire, |
| | * | | | ambulance, municipality, sehool |
| | | | | board, and public transit. |
| Clearing & | O: | 1—Late permits of right of the way | M2 | The Contractor may be required to |
| Grabbing | | 2—Work scope changes | | use close-cut, no grub practices. |
| | | 3—Differing site conditions | | “Clearing” Grubbing shall be fully |
| | C: | 1—Distant disposal area | | completed at least 300 m in advance |
| | | 2—Shortage or equipment breakdowns | | of grading operations. |
| | N: | 1—Bad weather | | |
| Survey & | O: | 1—Approval delay | M2 | Project manager must be notified for |
| Staking | C: | 2—Modifications in | | any conflict such as existing water |
| | | drawings/specifications | | line located at same location as the |
| | | 1—Error in benchmarking | | proposed sewer line. |
| | | 2—Unqualified workforce | | |
| | N: | 3—Difficulties in site conditions | | |
| | | 1—Bad weather | | |
| Excavation | O: | 1—Delay in inspection or testing | M3 | Maintain the stability of adjacent |
| | | 2—Differing site conditions | | ground |
| | C: | 1—Damage to existing utilities, poles, or | | All waste sites shall be vegetated |
| | | lines | | immediately after finishing disposal, |
| | | 2—Unavailability or delay of site utilities | | or develop suitable temporary |
| | N: | 3—Difficulties in site condition | | erosion control. |
| | | 1—Bad weather | | Excavation will be measured after |
| | | | | completing Clearing and Grubbing. |
| Grading | O: | 1—Delay in inspection or testing | M2 | All aggregates shall meet QC specs. |
| (Granular | C: | 1—Delay in material/equipment delivery | | No construction during snow, heavy |
| Surfacing | | 2—Equipment shortage or breakdowns | | rain, freezing or other unsuitable |
| base and | | 3—Traffic restrictions at job site | | conditions. |
| sub-base) | N: | 1—Bad weather | | |
| | | | | Aggregate te shall not be placed on |
| | | | | frozen, wet, or rutted subgrade, sub- |
| | | | | base, base, base or surface. |
| Underground | O: | 1—Delay in inspection or testing | Lump Sum | Precautions to protect existing utility |
| Utilities | | 2—Work scope changes | | services. |
| | C: | 1—Utility is not protected as required | | Ensure correct locations of the |
| | | 2—Relocation for utilities | | utilities. |
| | | 3—Unforeseen site events | | Contractor responsible to divert, |
| | N: | 1—Bad weather | | relocate or re-route utilities or other |
| | | | | facilities during the construction if |
| | | | | required. |
| Asphalt | O: | 1—Delay in inspection/testing | M2 | Avoid damage to the waterproofing |
| Paving | C: | 2—Errors or discrepancies in design | Ton | membrane. |
| | | documents | | Avoid excessive heat of paver screed |
| | | 1—Bad surface preparation | | burner. |
| | | 2—Asphalt paver breakdowns | | The paver shall move continuously |
| | N: | 3—Traffic restrictions at job site | | and at constant speed. |
| | | 1—Bad weather | | Hauling trucks shall maintain a |
| | | | | steady supply of asphalt mix to the |
| | | | | paver. |
| Concrete | O: | 1—Delay in inspection or testing | M3 | Secure reinforcing steel & dowels. |
| work | C: | 2—Errors or discrepancies in design | | Reinforcing steel shall be clean. |
| | | documents | | QC in batching, mixing, |
| | | 1—Bad surface preparation | | transporting, placing, consolidating, |
| | | 2—Delay in material/Equipment delivery | | finishing, curing & testing. |
| | N: | 3—Traffic restrictions at job site | | All concrete and other waste must be |
| | | 1—Bad weather | | prevented from entering any |
| | | | | watercourse. |
| Electrical | O: | 1—Late approval | Each | Contractor shall locate & protect |
| & Signage | | 2—Errors/Modifications in drawings/specs | | existing utilities. |
| | C: | 1—Error in sign work | | Contractor shall check for conflicts |
| | | 2—Shortage or low productivity of labors | | with overhead lines prior to |
| | | 3—Unforeseen site events | | excavating for concrete bases. |
| | N: | 1—Bad weather | | |

O*: Owner
C*: Contractor
N*: Neither (third-party)

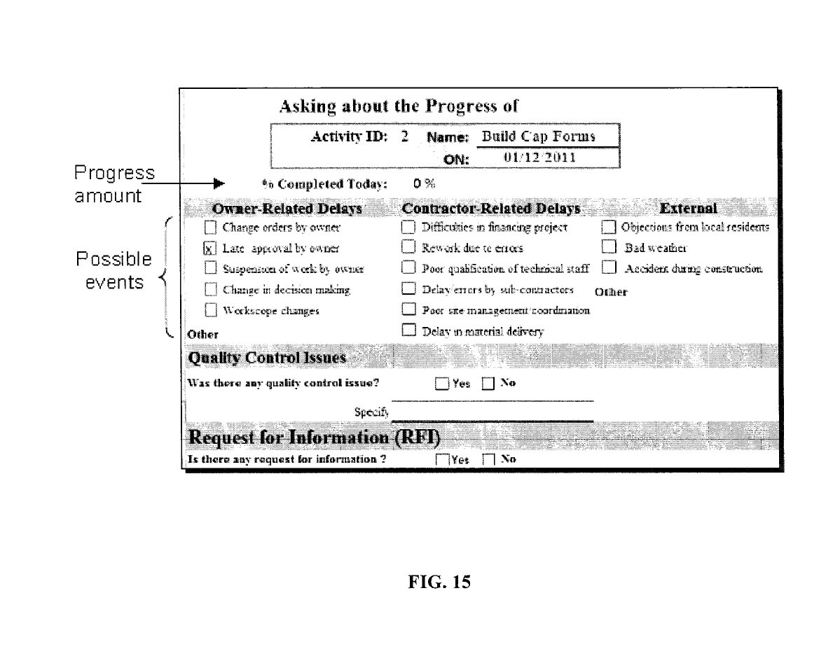

Based on this information, activity-specific email forms have been designed to collect as-built data. An example email form is shown in FIG. 15, which is an html file format (the format used in sending nicely formatted email messages). The form includes four categories of as-built information: Progress Measurement; Site Events; Information Request; and Quality Control Issues. Using this pre-designed email form, collecting as-built information becomes simple and fast.

### Email-Based Framework for As-Built Tracking

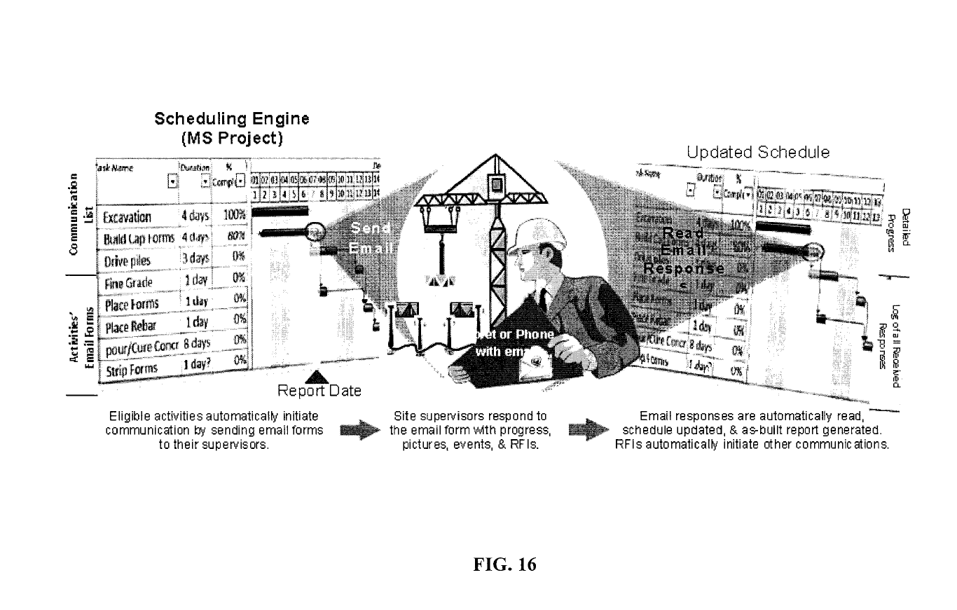

To facilitate automatic bidirectional communication between site and head office for as-built tracking purposes, an email-based framework has been developed with the following components (FIG. 16):

(1) A customized scheduling engine. Microsoft Project scheduling software has been utilized for its ease-of-use and programmability. The framework uses the VBA programming language of the software to allow activities to become aware of their planned progress and automatically initiate communications to request updates on actual progress;

(2) Activity-specific email forms discussed earlier (FIG. 15) as a data collection tool for progress updates, site events, and other requests for information;

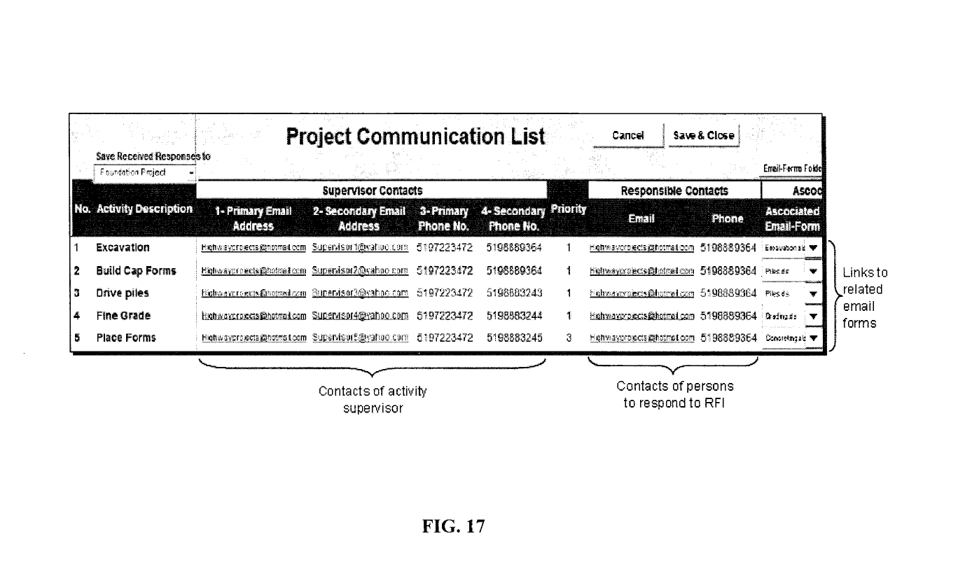

(3) A project communication list that defines the activities' communication parties, including the contacts of the supervisors who will respond to the email requests as well as the contacts of the parties responsible for answering any requests for additional information. This communication list has been implemented in an Excel spreadsheet, as shown in FIG. 17;

(4) A customized email communication tool. Microsoft Outlook has been selected for its programmability using the same VBA language; and

(5) A reporting tool that provides a log of aft communications and updated project status.

A prototype of the proposed framework has been developed incorporating the five aspects above. It enables the activities to automatically send progress requests to relevant supervisors, analyzes the received responses, and accordingly updates the project schedule. The system reduces the time needed for collecting, analyzing, and recording site information. To illustrate the detailed work flow of the system, a demonstration case study is discussed in the following section.

### As-Built Tracking: A Simple Case Study

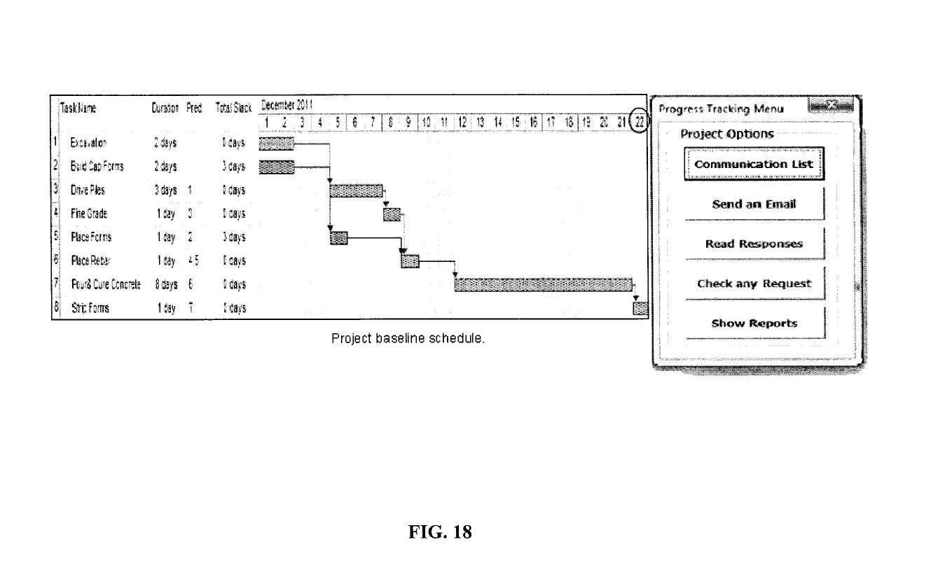

For demonstration purposes, the developed prototype system has been applied to a simple case study of a bridge-pier construction. The 8 activities involved in the case study and their estimated durations were defined in Microsoft Project software as shown in FIG. 18. The project is expected to take 16 working days (22 days including weekends), starting from Dec. 1, 2011. The main system options (FIG. 18) allow the user to modify the communication list, start email-based data collection, read the email responses, check for any Fries, update the schedule, and generate a full as-built report.

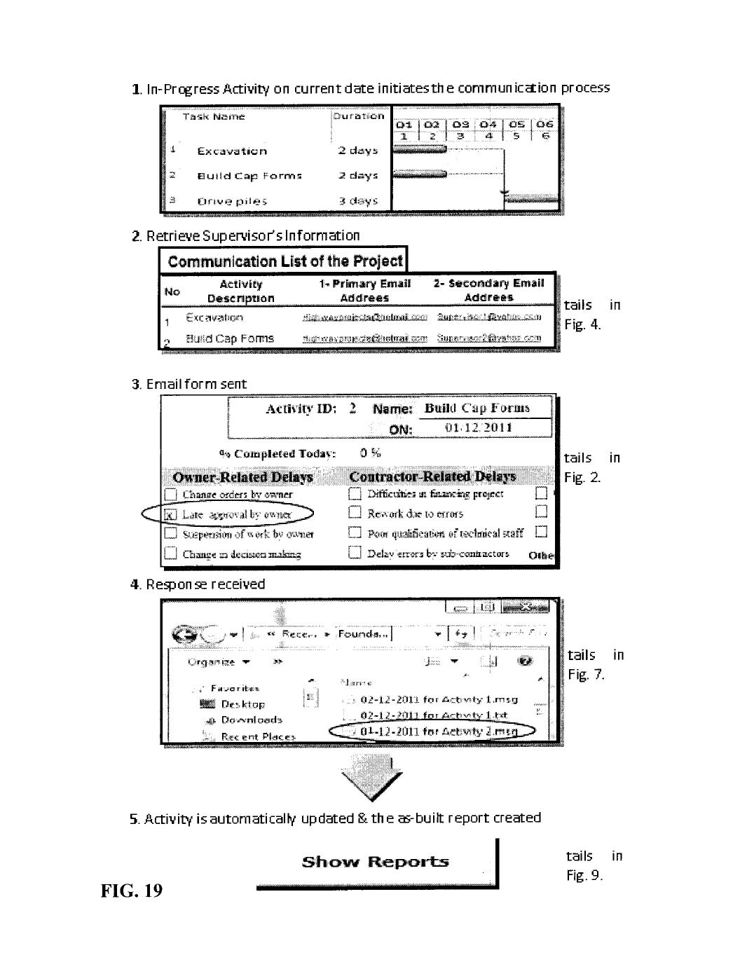

The process of as-built tracking, as it applies to the sample project, can be summarized as shown in FIG. 19. Detailed step-by step workflow is as follows:

(1) Identify progressing activities: When the user initiates the email data collection (can be set to self-initiate daily at a specific time), the process starts by automatically identifying the activities that are planned to start (their predecessors are completed), or still continuing on the current progress date, as highlighted in step 1 of FIG. 19. In the case study, activities 1 and 2 are the ones to start on the first day of the project.

(2) Retrieve the communication list: Upon identifying the eligible activities, the system retrieves the pre-defined project communication list and loads the email address for the activities' supervisor(s). In addition, the system also configures Microsoft Outlook with the email folder to receive the responses (Top of FIG. 17).

(3) Send email for progress request: In this step, the system automatically initiates a progress request by sending the email form, step 3 of FIG. 19, to the relevant supervisor(s).

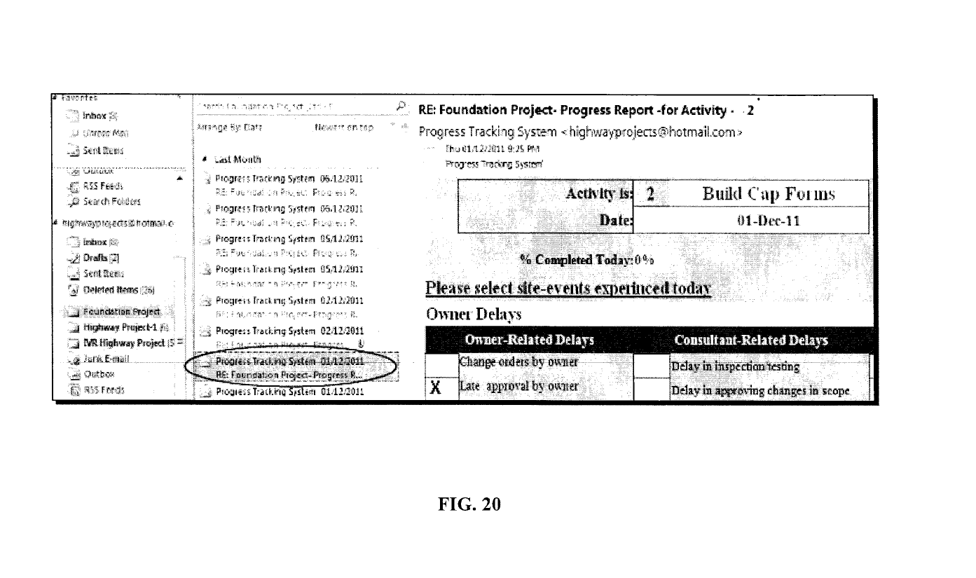

(4) Read responses: Once the supervisor(s) reply to the email request, the responses and any attachments are saved into the designated folder of Outlook, as shown in FIG. 20. The system then loads the latest email responses and reads the information, then saves it into the project database (step 4 in FIG. 19), along with other documents such as photos.

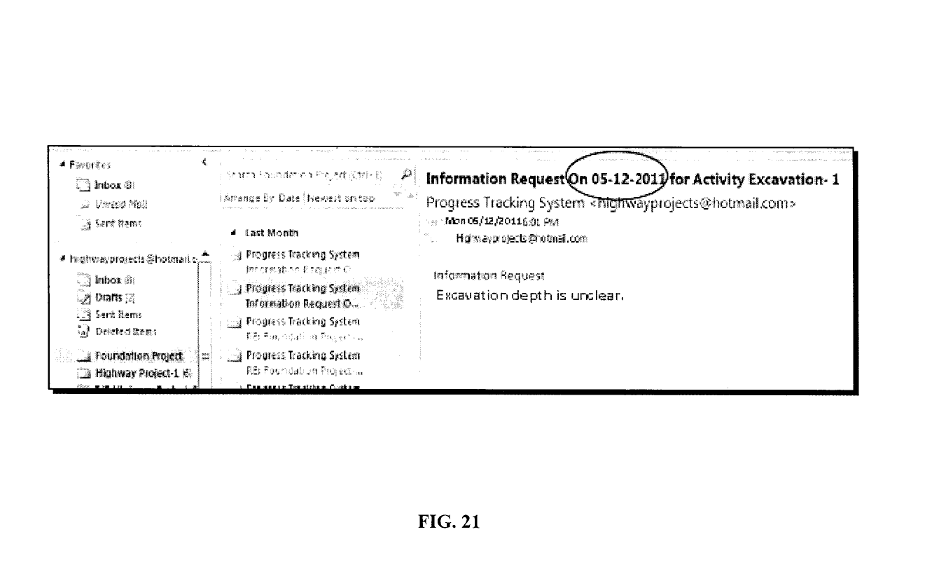

In this step also, the system automatically checks if there are any requests for information (RFI), quality control issues, or safety issues. For example, on December 5th, the excavation supervisor requested more information to clarify the excavation depth. Accordingly, upon receiving this request, the system automatically forwards it to the responsible person's email (FIG. 21) identified in the project communication list. The answer to this RFI is then sent back automatically to the supervisor. This bidirectional communication between site and head office is one of the clear advantage of the system to quick response to urgent needs and other issues such as quality control or productivity issue.

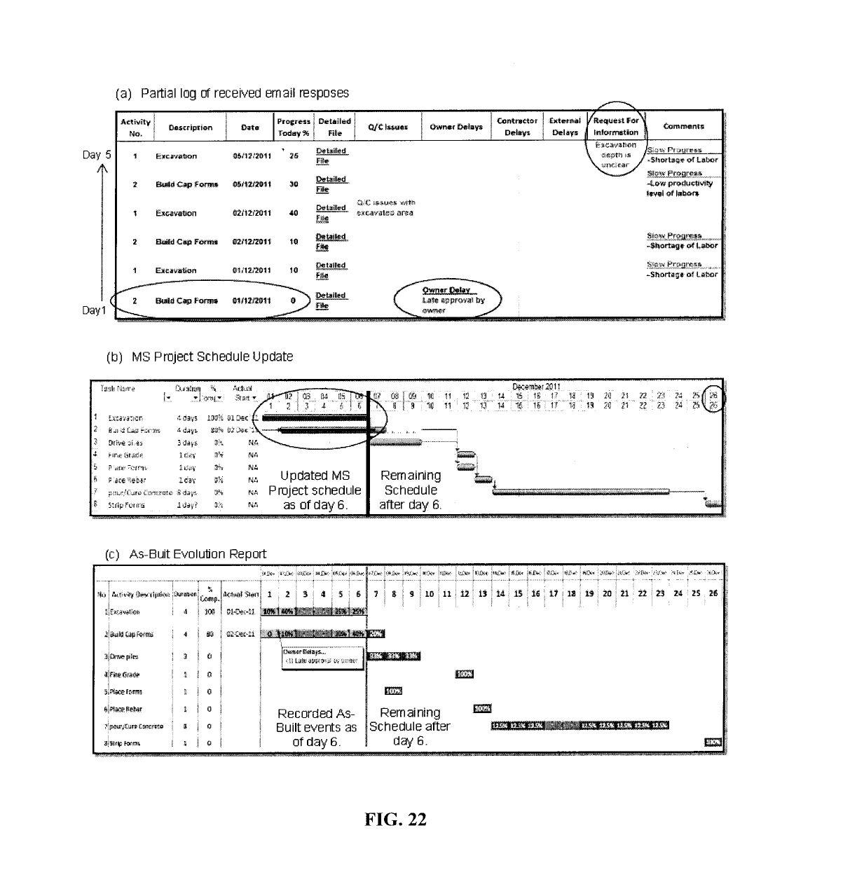

(5) Update project information: Upon reading the progress data, the system automatically updates the project schedule and saves all site events related to each activity along with any attached files in a log of all communications (FIG. 22a). Each row of the log represents a received response, which has all data and hyperlinks to all attached files. In addition to the detailed log, two important reports are generated automatically by the system: an automated update to the MS Project file of the project with the cumulative percentage complete for each activity adjusted according to latest information (FIG. 22b); and a detailed as-built schedule with the evolution of all events on a daily basis, with all details shown as comments on their associated days of the activities (FIG. 22c). Both reports shdw that the project duration is extended to 26 days (4 days delay). The MS Project schedule report can only show the bars of completed and on-going tasks being extended, without any progess details. The as-built report, on the other hand, provides all the daily details, with additional information shown as comments on the relevant days. At the end of day 1 (December 1st), for example, the status of activities “Excavation” and “Build cap forms” has been updated to show that Excavation experienced slow progress (10% on day 1, as opposed to 50% per its two-day planned duration). The reason for the slow progress was documented (in the email log and on the as-built schedule) as “Shortage of labor”, which is a contractor responsibility. On the same day, the cap forms activity had zero percentage complete due to owner's late approval of starting the work (Owner responsibility). The as-built report, therefore, is more informative and more suitable for corrective action planning and schedule analysis.

### System Performance and Future Extensions

The prototype system for as-built documentation has been applied to a number of case studies to test its functionality and potential improvements. While experimentation on a real life project is yet to be carried out, the initial experiments showed that the system has several benefits as a result of its structure and its implementation as an add-on to existing project management tools. Some of the observed benefits include the following:

The system integrates common affordable tools: Excel, MS project, and MS Outlook. All these tools have compatible versions of the VBA programming language and thus allow fast prototyping and full automation of the various functions of the system;

(1) Being implemented as an add-on to MS project enables the system to benefit from its wide array of built-in features. This includes easy-to-use procedures for defining the activities and their relationships; leveling of project resources; and handling large size projects;

(2) The activity-specific email form allows supervisors to respond in a speedy manner, attach photos, videos, voice notes, and text notes along with progress;

(3) Project activities are aware of their progress status and can initiate progress communication to collect data;

(4) The system has bidirectional communication ability and thus can respond in a timely manner to any requests for information;

(5) The automatically generated as-built schedule acts as a visualization and documentation tool for all the daily progress details (e.g., progress percentage, delays, responsible party, quality control issues, etc.). As such, it is very suited for facilitating corrective actions and for detailed schedule analysis; and

(6) The system automatically updates the schedule in MS projects and also generates a full as-built schedule report (as in FIGS. 22b and c). These two reports resemble the two cases discussed earlier in FIG. 14, which proved the value of the documenting daily as-built information.

The system and may be extended to improve its functionality and practicality through the following:

(1) Extend the scheduling engine to address projects that involve linear and/or repetitive activities;

(2) Enhance the scheduling engine using the Critical Path Segments (CPS) approach [33] which considers daily segmentation of activity durations to improve resource management and be compatible with the daily progress recording, of the proposed system;

(3) Allow variable progress-tracking frequency (daily, weekly, etc.) to be applied indifferent activities to suit their specific needs and to reduce the data collection effort;

(4) Extend the email communication system by incorporating a follow-up and reminder system for the supervisors to avoid delays in data collection;

(5) Extend the system to include interactive voice response (IVR) features so that the as-built information can be collected not only using email but also using telephones;

(6) Extend the as-built documentation to include not only the events that affect the schedule (as currently done) but also other important information such as the changes to as-built drawings, dimensions, locations, operational parameters, etc.; and

(7) Incorporate procedures for accurate schedule analysis and corrective action optimization to support decisions for recovering delays and keeping projects on track.

Thus, in another aspect, this disclosure presents an effort towards developing a simplified and low-cost framework to automate daily as-built tracking from construction site personnel, using emails. Based on a thorough understanding of activity tracking needs, a progress tracking email form has been developed for each activity, incorporating all possible site events. The proposed framework has been applied to simple case study of a bridge-pier foundation construction to demonstrate the proposed concept. The framework has the potential to minimize the time and cost associated with site information collection, schedule updating, report generation, and initiation of warning signs. Such system is expected to help construction firms have better control over construction operations and provide timely information for decision making. The framework allows bidirectional communication and can be extended to include voice (telephone) and visual (tablet or pad) which are affordable technologies at the hands of site personnel. The proposed framework shows an example of using common communication technology to improve collaboration and greatly enhance work productivity in construction, which can be replicated in other domains.

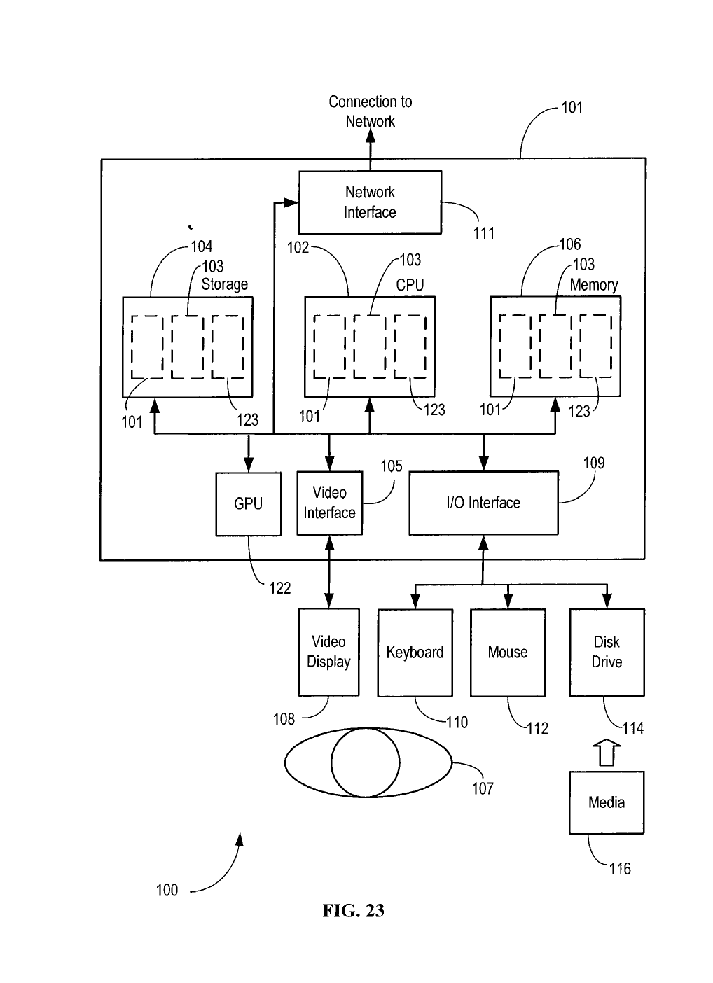

Now referring to FIG. 23, the present system and method may be practiced in various embodiments. A suitably configured generic computer device, and associated communications networks, devices, software and firmware may provide a platform for enabling one or more embodiments as described above. By way of example, FIG. 23 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate through wired or wireless communications with other suitably configured data processing systems (not shown). The generic computer device 100 may be embodied in various form factors including desktop and laptop computers, and wireless mobile computer devices such as tablets, smart phones and super phones operating on various operating systems. It will be appreciated that the present description does not limit the size or form factor of the computing device on which the present system and method may be embodied.

In summary, constrained resource scheduling (CRS) and time-cost trade-off (TCT) problems have attracted many researchers in the past few decades. The present system and method provides decision support tools for resolving both time and resource constraints in projects are long overdue. This disclosure first discussed the representation of two activity variables (start delay and construction method index) that suit CRS and TCT decisions. The present disclosure then proposed an efficient heuristic approach for combined CRS and TCT analyses to resolve both time and resource constraints simultaneously. The proposed approach is simple enough to be applied manually for educational purposes. To demonstrate its ability to be incorporated into existing software tools for scheduling projects, the proposed procedure has been programmed as an add-in tool to Microsoft Project software. Experimenting on several cases proved the ability of the proposed procedure to produce good repeatable solutions fast. The procedure can be used not only to determine a feasible construction schedule but can also be applied throughout the construction process to keep projects on track.

Thus, in an aspect, the present disclosure relates to a framework and procedures for project management for use in schedule optimization and voice/visual tracking and control of projects having plurality of interrelated activities, wherein activities can be repetitive or non-repetitive; a project can comprise linear, non-linear, and scattered subprojects; and a scheduling method can be the critical path method (CPM), critical path segments (CPS), or a combination. Wherein, the said CPM method uses continuous activity duration while the CPS method segments activity duration into separate time segments and allows a documentation of mid-activity events using different types of time segments in the various activities, including resource-delay time segment, progress time segment, milestone time segment, rework time segment, contractor-delay time segment, owner-delay time segment, third-party event time segment, or any other time segment of any planned, actual, or proposed event that may occur to a project activity. The framework comprises: employing at least one algorithm and device to establish audio/visual progress monitoring for actual events on activity time segments. Said algorithm comprises variety of means for automating the said documentation of mid-activity events, including disclosure-based, hand-held devices with 2D/3D charts and Building Information Models (BIM), voice-based wireless communication, telephony, phone, electronic mail, web-based social networks, and text messages. Said algorithm and device incorporate at least one algorithm for managing pictures, voice recordings, and other documents wherein said device may incorporate at least one method of outdoor and indoor positioning; employing at least one heuristic schedule optimization algorithm that utilize the said documentation of mid-activity events to determine a schedule that meets multiple constraints on activities, time segments, subprojects, and projects, wherein constraints include milestones, work continuity constraints on resources, availability limits of resources to the activities and the time segments, budget limit, deadlines, logical relations, and other types of constraints. Said algorithm optimizes the schedule, properly allocates resources to time segments, meets deadlines, minimizes cost, and decides best execution methods; employing at least one evolutionary, mathematical, or combined optimization algorithm to establish a large-scale multi-project schedule optimization, where said algorithm optimizes resource use, project duration, cost, and meets other types of said constraints. Said algorithm establishes the optimum schedule and compares it to the results of the said heuristic schedule optimization algorithm; employing at least one algorithm to establish a schedule control method and analyze delays and corrective actions; and employing at least one algorithm to establish a visual reporting system, wherein such algorithm may use geographic information systems, linear and repetitive scheduling charts, and critical segment chart to represent all said types of schedules.

In another aspect, the present disclosure relates to framework and procedures for project management for use in scheduling and tracking projects having a plurality of interrelated activities, wherein activities can be repetitive or non-repetitive, and projects can comprise linear, non-linear, and scattered subprojects. The framework comprises: a procedure for separating the duration of each said activity into chained consecutive time segments wherein the length of a time segment can be a month, a day, an hour, a minute, or a second, or any other time unit. An activity can involve a combination of time segment lengths; said framework and procedures use different types of time segments in the various activities, including resource-delay time segment, progress time segment, milestone time segment, rework time segment, contractor-delay time segment, owner-delay time segment, third-party event time segment, or any other time segment of any planned, actual, or proposed event that may occur to a project activity; a procedure for converting each schedule relationship between two said activities, where said relationship can be of different types including start-to-start, finish-to-finish, and start-to-finish with any lead or lag times, into finish-to-start relationship between appropriate time segments of the two activities; a procedure for legible documentation of mid-activity events using various types of time segments to establish planned, actual (as-executed or as-built), and proposed (corrective action) project schedules; employing at least one algorithm for scheduling activities' time segments to determine the start and finish dates of each said time segment of each activity. Said algorithm also determines the critical, non-critical, and float time segments, wherein activities can be repetitive or non-repetitive, and projects can comprise linear, non-linear, and scattered subprojects. Said algorithm also considers all said types of activity time segments encountered during planned, actual, or proposed events. Said algorithm also considers the work continuity requirements of the resources involved in the activities, the availability limits of resources to the activities and the time segments, and the budget, resource, deadline and other constraints on a project, subproject, an activity, and any time segment of any activity; and employing at least one algorithm to establish a visual reporting system, wherein such algorithm may use geographic information systems, linear and repetitive scheduling charts, and critical segment chart to represent all said types of schedules.

While illustrative embodiments of the invention have been described above, it will be appreciate that various changes and modifications may be made without departing from the scope of the present invention.

### References

Ammar, M. (2011). “Optimization of project time-cost trade-off problem with discounted cash flows.” Journal of Construction Engineering and Management, ASCE, 137(1), 65-71.
Chassiakos, A. P., and Sakellaropoulos, S. P. (2005). “Time-cost optimization of construction projects with generalized activity constraints.” Journal of Construction Engineering and Management, ASCE, 131(10), 1115-1124.
Chen, P. H. and Weng, H. (2009) “A two-phase GA model for resource constrained project scheduling,” Automation in Construction, 18(4), 485-498.
Christodoulou, S. E., Ellinas, G., and Michaelidou-Kamenou, A. (2010). “Minimum Moment Method for Resource Leveling Using Entropy Maximization.” Journal of Construction Engineering and Management, ASCE, 136(5), 518-527.
Elazouni, A. and Metwally, F. (2007). “Expanding Finance-Based Scheduling to Devise Overall-Optimized Project Schedules” Journal of Construction Engineering and Management, ASCE, 133(1), 86-90.
Elmaghraby, S. (1993). “Resource allocation via dynamic programming in activity networks.” European Journal of Operational Research, 64 (2), 199-215.
Eshtehardian, E., Afshr, A., and Abbasnia, R. (2008). “Time-cost optimization: using GA and fuzzy sets theory for uncertainties in cost.” Construction Management and Economics, 26, 679-691.
Gould, F. E. (2005). Managing the Construction Process: Estimating, Scheduling and Project Control. Pearson Education, Inc,.Upper Saddle River, N.J., USA.
Hariga, M. and El-Sayegh, S. (2011). “Cost optimization model for the multiresource leveling problem with allowed activity splitting.” Journal of Construction Engineering and Management, ASCE, 137(1), 56-64.
Harris, R. B. (1990). “Packing method for resource leveling (pack).” Journal of Construction Engineering and Management, ASCE, 116(2), 331-350.
Hegazy, T. (2006) “Simplified Project Management for Construction Practitioners,” Cost Engineering Journal, AACE International, vol. 48, No. 11, pp. 20-28.
Hegazy, T. (2002). Computer-Based Construction Project Management. Prentice Hall, Upper Saddle River, N.J., USA.
Hegazy, T. (1999). “Optimization of resource allocation and leveling using genetic algorithms.” Journal of Construction Engineering and Management, ASCE 125 (3), 167-175.
Hiyassat, M. A. S. (2001). “Applying modified minimum moment method to multiple resource leveling.” Journal of Construction Engineering and Management, ASCE, 127 (3), 192-198.
Jiang, G. and Shi, J. (2005). “Exact Algorithm for Solving Project Scheduling Problems under Multiple Resource Constraints.” Journal of Construction Engineering and Management, ASCE, 131 (9), 986-992.
Kandil, A, and El-Rayes, K. (2005) “Parallel Computing Framework for Optimizing Construction Planning in Large Scale Projects,” Journal of Computing in Civil Engineering, ASCE, 19 (3), 304-312.
Kastor, A., and Sirakoulis, K. (2009). “The effectiveness of resource levelling tools for resource constraint project scheduling problem.” International journal ofproject management, 27 (5), 493-500.
Leu, S. and Yang, C. (1999) “GA-based multicriteria optimal model for construction scheduling,” Journal of Construction Engineering and Management, ASCE, 125 (6), 420-427.
Lu, M., and Li, H. (2003). “Resource-activity critical-path method for construction planning.” Journal of Construction Engineering and Management, ASCE, 129(4), 412-420.
Lucko, G. (2011). “Integrating Efficient Resource Optimization and Linear Schedule Analysis with Singularity Functions.” Journal of Construction Engineering and Management, ASCE, 137 (1), 45-55.
Rogalska, M., Bożejko, W., and Hejducki, Z. (2008). “Time/cost optimization using hybrid evolutionary algorithm in construction project scheduling.” Automation in Construction, 18(1), 24-31.
Senouci, A. and Eldin, N. (2004) “Use of genetic algorithms in resource scheduling of construction projects,” Journal of Construction Engineering and Management, ASCE, 130(6), 869-877.
Son, J., and Mattila, K. (2004). “Binary resource leveling model: Activity splitting allowed.” Journal of Construction Engineering and Management, ASCE, 130 (6), 887-894.
Son, J., and Skibniewski, M. (1999). “Multiheuristic approach for resource leveling problem in construction engineering: Hybrid approach.” Journal of Construction Engineering and Management, ASCE, 125 (1), 23-31.
Vanhoucke, M., Debels, D., (2007). “The discrete time/cost trade-off problem: extensions and heuristic procedures.” Journal of Scheduling, 10, 311-326
Wuliang, P. and Chengen, W. (2009). “A multi-mode resource-constrained discrete time-cost tradeoff problem and its genetic algorithm based solution.” International Journal of Project Management, 27, 600-609
Zahraie, B. and Tavakolan, M. (2009). “Stochastic time-cost-resource utilization optimization using nondominated sorting genetic algorithm and discrete fuzzy sets.” Journal of Construction Engineering and Management, ASCE, 135(11), 1162-1171.
Allmon, E., Haas, C. T., Borcherding, J. D., and Goodrum, P. M., “U.S. construction labor productivity trends,” 1970-1998, Journal of Construction Engineering and Management, ASCE, 2000; 126 (2): pp 97-104.
Davidson I. N. and Skibniewski M. J. “Simulation of automated data collection in buildings,” Journal of Computing in Civil Engineering, 1995; 9(1): pp 9-20.
De la Garza, J.M. and Howitt, I., “Wireless communication and computing at the construction jobsite,” Journal of Automation in Construction, 1998; 7(4): pp 327-347.
Gajamani, G. K., Varghese, K., “Automated project schedule and inventory monitoring using RFID,” 24th International Symposium on Automation in Robotics in Construction (ISARC), 2007.
Ghanem, A., “Real-time construction project progress tracking: a hybrid model for wireless technologies selection, assessment, and implementation,” PhD. Thesis, University Of British Columbia, Canada, 2007.
Hwang, S., Trupp, T. and Liu, L., “Needs and trends of IT-based ,construction field data collection, Proceedings Towards a Vision for Information Technology in Civil Engineering,” 4th Joint International Symposium on Information Technology in Civil Engineering, pp 1-9, Nashville, 2003.
Korde, T. “Visualization of construction data,” MSc Thesis, University Of British Columbia, Canada, 2005.
McCullouch, B. “Automating field data collection in construction organizations,” 4th ASCE Construction Congress, ASCE, Minneapolis, Minn., 1997.
Moura, H. and Texeira, J. C. “Why can't main project managemeW functions be achieved in most construction projects?,” 1st ICEC and IPMA Global Congress Incorporating the 5th ICEC World Cost Engineering, Project Management, Cost Management and Quantity Surveying Congress, pp 23-26, Ljubljana, Eslovénia, 2006.
Navon R. and Sacks R. “Assessing research issues in automated project performance control (APPC),” Journal of Automation in Construction, 2007; (16): pp 474-484.
Navon, R. “Automated project performance control of construction projects,” Journal of Automation in Construction, 2005; (14): pp 467-476.
Reinhardt, J., Akinci, B., and Garrett, J. H. “Navigational models for computer supported project management tasks on construction sites,” Journal of Computing in Civil En_{g}ineering, 2004; 18(4): pp 281-290.
Russell, A. D., Chiu, C-Y, and Korde, T. “Visual representation of construction management data, “Journal of Automation in Construction, 2009; (18): pp.1045-1062.
Scott, S. and Assadi, S. “A survey of the site records kept by construction supervisors,” Journal of Construction Management and Economics, 1999; 17(3): pp 375-382
Trupp, T., Soibelman, L., Hashash, T. M. A., and Liu, L. Y. “Novel technologies for construction field data collection,” International Conference on Computing in Civil and Building Engineering, ICCCBE, 10, Weimar, Germany, 2004.
Wang, L.-C., Lin, Y.-C., Lin, P.H. “Dynamic mobile RFID-based supply chain control and management system in construction,” Advanced Engineering Informatics, 2007; (21): pp 377-390.
[1] L-C Wang, Y-C. Lin, and P. H. Lin, Dynamic mobile RFID-based supply chain control and management system in construction, Advanced Engineering Informatics 21 (2007) 377-390.
[2] L. Y. Liu, Hand-held Multimedia Documentation for Tunnel Inspection, Proceedings of the Eighth Congress on Computing in Civil Engineering, ASCE, 2000.
[3] T. Korde, 2005. Visualization of construction data, MSc Thesis, University Of British Columbia, Canada.
[4] I. N. Davidson and M. J. Skibniewski, Simulation of automated data collection in buildings, Journal of Computing in Civil Engineering, ASCE 9 (1) (1995) 9-20.
[5] R. Navon, Research in automated measurement of project performance indicators, Journal of Automation in Construction 16(2) (2007)176-188.
[6] T. Trupp, L. Soibelman, T. M. A. Hashash, and L. Y. Liu, Novel technologies for construction field data collection, International Conference on Computing in Civil and Building Engineering, ICCCBE 10 (2004), Weimar, Germany.
[7] B. McCullouch, Automating field data collection in construction organizations, 4th ASCE Construction Congress, ASCE, Minneapolis, Minn., 1997.
[8] R. Navon and R. Sacks, Assessing research issues in automated project performance control (APPC), Journal of Automation in Construction 16 (2007) 474-484.
[9] S. Chin, S-W. Yoon, Y-S. Kim, Y-S. Jung, S-C Park, and M. Chung, A project progress measurement and management system, Proceedings of 21st International Symposium on Automation and Robotics in Construction, Jeju, S. Korea, 2004.
[10] R. Navon, and I. Haskaya, Is detailed progress monitoring possible without designated manual data collection?, Construction Management and Economics 24 (12) (2006) 1225-1229
[11] 0. Y. Abudayyeh, A multimedia construction delay management system, Journal of Microcomputers in Civil Engineering 12 (1997) 183-192.
[12] J. Sunkpho, and J. H. Garrett, Opportunities to use speech recognition for bridge inspection, Proceedings of Construction Congress VI, Orlando, Fla., 2000.
[13] M-K Tsai, J-B Yang, and C-Y Lin, Integrating wireless and speech technologies for synchronous on-site data collection, Journal of Automation in Construction 16 (2007) 378-391.
[14] M-K Tsai, Improving communication barriers for on-site information flow: An exploratory study, Journal of Advanced Engineering Informatics 23(2009) 323-331.
[15] C. Liao and P. Tseng, Influential factors of Voip adoption of top 500 export- import enterprises in Taiwan, Journal of Contemporary Management Research 6(1)(2010)11-28.
[16] T. Hegazy, M. Attalla, L. Hayter, and S. Penny, Ultra mobile computer system for accurate and speedy inspection of buildings, CSCE Annual Conference, Québec, Canada, 2008.
[17] H. P. Tserng, and R-JDzeng, Mobile construction supply chain management using PDA and bar codes, Journal of Computer-Aided Civil and Infrastructure Engineering 20 (4) (2005) 242-264
[18] S. O. Cheung, H. C. H. Suen, and K. K. W. Cheung, PPMS: a Web-based construction Project Performance Monitoring System 13(3) (2004) 361-376.
[19] A.P. Chassiakos and S.P. Sakellaropoulos, A web-based system for managing construction information. Journal of Advances in Engineering Software 39 (2008) 865-876.
[20] S. Ahsan, A. El-Hamalawi, D. Bouchlaghem, and S. Ahmad, Applications of converged networks in construction, International Journal of Product Development, 7 (3/4)(2009) 281-300.
[21] G. K. Gajamani and K. Varghese, Automated project schedule and inventory monitoring using RFID, Proc. 24th International Symposium on Automation and Robotics in Construction (ISARC) Construction Automation Group, I.I.T. Madras, (2007) 47-53.
[22] T. Shehab, O. Moselhi, and E. Nasr, Barcode-assisted system for document management of construction projects, International Journal of Construction Education and Research 5(1)(2009) 45- 60
[23] O. Moselhi and S. El-Omari, Integrating automated data acquisition technologies for progress reporting of construction projects, 26th International Symposium on Automation and Robotics in Construction, 2009.
[24] J. Song, C. Haas, C. Caldas, E. Ergen, and B. Akinci, Automating the task of tracking the delivery and receipt of fabricated pipe spools in industrial project. Journal of Automation in Construction 15(2006) 166-177.
[25] F. Bosche, C. T. Haas, and P. Murray, Performance of automated project progress tracking with 3d data fusion, CSCE Annual Conference, 2008, Québec, Canada.
[26] F. Kern, Precise determination of volume with terrestical 3D laser scanner, Proceeding 2nd symposium on geodesy for geotechnical and structural engineering II (2002) 531-534, Berlin, Germany.
[27] S. El-Omari and O. Moselhi, Hybrid methodology for automated collection of data from construction sites, International Symposium on Automation & Robotics in Construction ISARC, Kochi, Kerala, India, 2007.
[28] T. Hegazy, and W. Menesi, Delay analysis under multiple baseline updates. Journal of Construction Engineering and Management, ASCE 134(8)(2008) 575-582.
[29] S. A. Assaf and S. Al-Hejji, Causes of delay in large construction projects. International Journal of Project Management 24 (2006) 349-357.
[30] S. Ahmad, S. Azher, M. Castillo, P. Kappagantula, Construction delays in Florida: An empirical study Florida (2002), (http://www.cm.fiu.edu/pdfs/Research_Reports/Delays_Project.pdf)
[31] R. D. Ellis and H. R. Thomas, The Root Causes of Delays in Highway Construction. 82nd Annual Meeting of the Transportation Research Board, Transportation Research Board, Washington, D.C., 2003.
[32] Ministry of Transportation and Infrastructure, Standard Specifications for Highway Construction. Ministry of Transportation and Infrastructure, British Columbia, Calif., 2012. (Accessed online on November, 29 at http://www.th.gov.bc.ca/publications/const_maint/contract_serv/standard_specs/Volume_{—}1_SS2 012.pdf).
[33] T. Hegazy and W. Menesi, Critical Path Segments (CPS) scheduling technique.” Journal of Construction Engineering and Management, ASCE, 136(10), 2010, 1078-1085

1. A computer implemented method for schedule optimization, comprising:
starting a time-cost trade-off (TCT) analysis by resetting project activities to their cheapest options with the longest project duration;
in any TCT cycle, while all critical activities are not crashed, selecting and crashing the cheapest critical activities one-by-one to reduce the project's critical path;
in any TCT cycle, when all critical project activities are crashed, then crashing the cheapest non-critical activities one-by-one;
performing a constrained resource scheduling (CRS) analysis at the end of each TCT cycle to meet project resource limits and provide at least one feasible solution for a project duration that does not violate project resource limits; and
saving the best solution with cheapest total cost from any cycle.

2. The computer implemented method of claim 1, further comprising:
for each CRS analysis at the end of each TCT cycle, calculating the solution's associated values of start delays and construction methods; and
for each TCT cycle, considering all costs including the direct costs of the methods, in addition to total indirect costs, penalty for longer project duration beyond the deadline, and incentive for shorter project duration.

3. The computer implemented method of claim 1, further comprising:
as an initial step prior to optimization, determining whether all project activities meet exiting project constraints when setup to use their fastest construction methods;
comparing the resulting minimum project duration with a deadline constraint; and
if the deadline cannot be met, then seeking more crashing options to meet the deadline constraint.

4. The computer implemented method of claim 1, further comprising:
once a possible final solution is obtained, relaxing a crashed project activity to see if using a slower method results in a reduced cost or same cost without violating project resource limits, and if so, then retaining the relaxed project activity to reduce or maintain the total cost.

5. The computer implemented method of claim 1, further comprising displaying the crashed activities and the final solution in a graphical display to visually identify the project's critical path.

6. A system for schedule optimization, wherein the system is adapted to:
start a time-cost trade-off (TCT) analysis by resetting project activities to their cheapest options with the longest project duration;
in any TCT cycle, while all critical activities are not crashed, select and crash the cheapest critical activities one-by-one to reduce the project's critical path;
in any TCT cycle, when all critical project activities are crashed, then crash the cheapest non-critical activities one-by-one;
perform a constrained resource scheduling (CRS) analysis at the end of each TCT cycle to meet project resource limits and provide at least one feasible solution for a project duration that does not violate project resource limits; and
save the best solution with cheapest total cost from any cycle.

7. The system of claim 6, wherein the system is further adapted to:
calculate the solution's associated values of start delays and construction methods for each CRS analysis at the end of each TCT cycle; and
for each TCT cycle, consider all costs including all the direct costs of the methods, in addition to total indirect costs, penalty for longer project duration beyond the deadline, and incentive for shorter project duration.

8. The system claim 6, wherein the system is further adapted to:
determine whether all project activities meet exiting project constraints when setup to use their fastest construction methods as an initial step prior to optimization;
compare the resulting minimum project duration with a deadline constraint; and
if the deadline cannot be met, then seek more crashing options to meet the deadline constraint.

9. The system of claim 6, wherein the system is further adapted to relax a crashed project activity once a possible final solution is obtained to see if using a slower method results in a reduced cost or same cost without violating project resource limits, and if so, then retain the relaxed project activity to reduce or maintain the total cost.

10. The system of claim 6, wherein the system is further adapted to display the crashed activities and the final solution in a graphical display to visually identify the project's critical path.

11. A computer implemented method for collecting data for schedule optimization, comprising:
automatically identifying and selecting an eligible project activity for which a progress update is required, and obtaining contact information for a user device associated with the project activity;
initiating contact with the user device to request a progress update;
collecting from the user device required progress information for the project activity; and
updating progress information for the project activity based on the progress update collected from the user device.

12. The computer implemented method of claim 11, further comprising:
requesting a progress update including one or more of a reason for a delay, a party responsible for the delay, and supporting documents; and
updating progress information for the project activity including one or more of the reason for delay, the party responsible, and supporting documents.

13. The computer implemented method of claim 11, further comprising:
receiving a request for action (RFA) or a request for information (RFI) from a user device; and
automatically initiating contact with a resource person responsible for responding to the RFA or RFI.

14. The computer implemented method of claim 11, wherein the user device includes a voice-component, and the method further comprises requesting a progress update via an automated voice command interface.

15. The computer implemented method of claim 11, wherein the user device includes a visual component, and the method further comprises requesting a progress update via a two-dimensional or a three-dimensional visual interface.

16. The computer implemented method of claim 15, wherein the visual interface includes an electronic text interface including a form requesting the progress update.

17. The computer implemented method of claim 15, wherein the visual interface includes a graphical digital image of the location of one or more constructed elements for which an as-built progress update is required.

18. The computer implemented method of any one of claim 11 to 15, further comprising displaying on a display a progress update for a project for schedule optimization.

19. A system for collecting data for schedule optimization, wherein the system is adapted to:
automatically identify and select an eligible project activity for which a progress update is required, and obtaining contact information for a user device associated with the project activity;
initiate contact with the user device to request a progress update;
collect from the user device required progress information for the project activity; and
update progress information for the project activity based on the progress update collected from the user device.

20. The system of claim 19, wherein the system is further adapted to:
request a progress update including one or more of a reason for a delay, a party responsible for the delay, and supporting documents; and
update progress information for the project activity including one or more of the reason for delay, the party responsible, and supporting documents.

21. The system of claim 19, wherein the system is further adapted to:
receive a request for action (RFA) or a request for information (RFI) from a user device; and
automatically initiate contact with a resource person responsible for responding to the RFA or RFI.

22. The system of claim 19, wherein the user device includes a voice-component, and the system is further adapted to request a progress update via an automated voice command interface.

23. The system of claim 19, wherein the user device includes a visual component, and the system is further adapted to request a progress update via two-dimensional or a three-dimensional visual interface.

24. The system of claim 19, wherein the visual interface includes an electronic text interface including a form requesting the progress update.

25. The system of claim 19, wherein the visual interface includes a graphical digital image of the location of one or more constructed elements for which an as-built progress update is required.

26. The system of claim 19, of any one of claims 11 to 15, further comprising a display for displaying a progress update for a project for schedule optimization.
